(19) United States
(12) Patent Application Publication
(10) Pub. No.: US 2026/0329251 A1
(43) Pub. Date: Oct. 22, 2026

(54) SYSTEM

(71) Applicant: SoftBank Group Corp., Tokyo (JP)

(72) Inventor: Akari KIDO, Tokyo (JP)

(73) Assignee: SoftBank Group Corp., Tokyo (JP)

(21) Appl. No.: 19/648,652

(22) Filed: Apr. 15, 2026

(30) Foreign Application Priority Data
Apr. 22, 2025 (JP) 2025-070675

(51) Int. Cl. G05B 19/4063; G05B 23/02; G06V 10/80; G06V 10/82; G06V 20/52; G06V 40/10; G08B 21/02

(52) U.S. Cl. CPC G05B 19/4063; G05B 23/0221; G05B 23/024; G05B 23/0283; G06V 10/806; G06V 10/82; G06V 20/52; G06V 40/10; G08B 21/02

(57) ABSTRACT

The present invention relates to a comprehensive health and safety management system that, in a facility for the elderly such as a nursing home, collects an activity status and biological information in real time from a plurality of cameras installed in the facility and a wearable terminal worn by each resident, automates early detection of an abnormality and severity determination by analyzing various data such as walking, a fall, eating, excretion, sleeping, wandering, a heart rate, a body temperature, and a blood oxygen concentration with high accuracy using generative AI, and realizes prompt notification to a staff and a family member, information visualization on a management screen, and long-term storage and reuse of data, and aims to reduce a labor shortage and a work burden, and improve service quality and safety.

### CROSS-REFERENCE TO RELATED APPLICATION

The present application claims priority to and incorporates by reference the entire contents of Japanese Patent Application No. 2025-070675 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to comprehensively and practically solve a wide variety of on-site problems, such as the fact that, in a facility for the elderly such as a nursing home, although it is necessary to appropriately and efficiently manage a health condition and a daily activity status of residing elderly people on a 24-hour basis, a chronic labor shortage and an increased burden on staff are becoming serious on-site, making it difficult to achieve early detection of an abnormality and a prompt response by conventional visual observation, regular patrols, and manual record management, furthermore, a system for immediately leading to appropriate care and medical care in response to an emergency such as a fall, a sudden illness, and a sudden change in physical condition of an elderly person has not been sufficiently constructed, in addition, when a family member is in a remote location, there is a risk that grasping the condition of the elderly person and an emergency contact may be delayed, and recording, explaining, and reporting work for health management and an abnormality response by a facility staff becomes complicated, making it difficult to maintain service quality and safety, and specifically, the present invention aims to significantly improve safety, a sense of security, and work efficiency in the facility for the elderly by automatically analyzing various data obtained from a camera and a wearable terminal by generative AI, and realizing early detection of an abnormality, prompt notification to a related person, efficiency improvement of health management, information sharing with a family member, and automation of recording work.

### SUMMARY OF THE INVENTION

A means for solving the problem according to the present invention is to configure a system comprising a camera information acquisition unit, a biological information acquisition unit, and an abnormality detection and notification unit. Specifically, the camera information acquisition unit acquires video data regarding an activity status of each resident in real time from a plurality of cameras installed in a facility such as a nursing home, individually determines actions such as walking, eating and drinking, excretion, and sleeping by image recognition processing using generative AI, and records these pieces of activity information in chronological order. The biological information acquisition unit acquires biological information such as a heart rate, a body temperature, a blood pressure, and a blood oxygen concentration at regular intervals from a wearable terminal worn by each resident, transmits the biological information to a cloud server, and accumulates the biological information for each individual. The abnormality detection and notification unit analyzes activity status data and biological information data obtained from the camera information acquisition unit and the biological information acquisition unit by the generative AI, automatically activates an AI application to notify a terminal of a care staff or a medical staff of abnormality details when the data corresponds to a preset threshold value or an abnormality pattern, and further automatically notifies a family member of a registered emergency contact of necessary information in a case of a serious abnormality, whereby it is possible to comprehensively solve problems such as an on-site labor shortage, efficiency improvement of health management, early detection of an abnormality and a prompt response, and information sharing with a family member.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

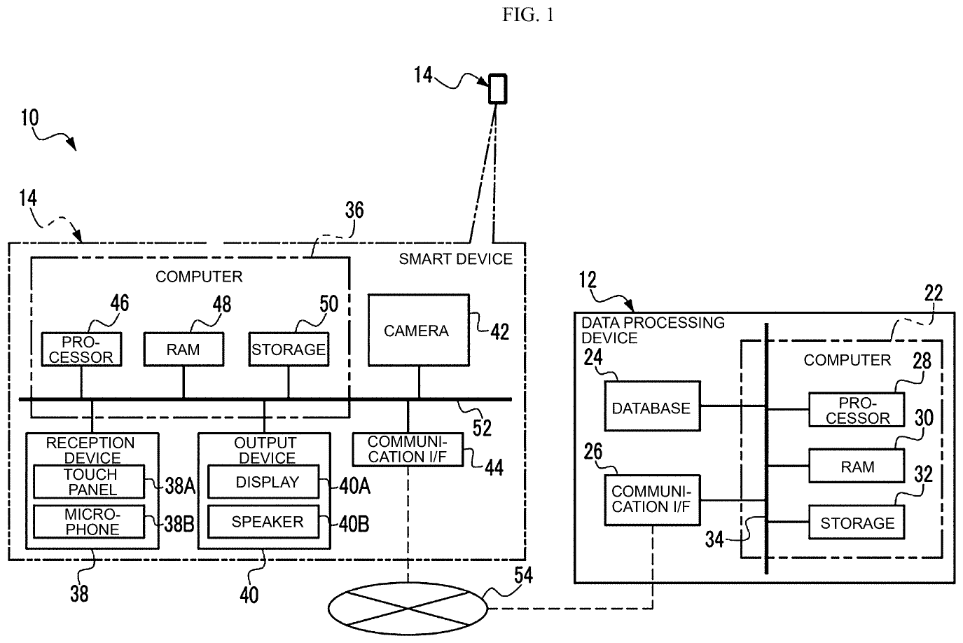

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

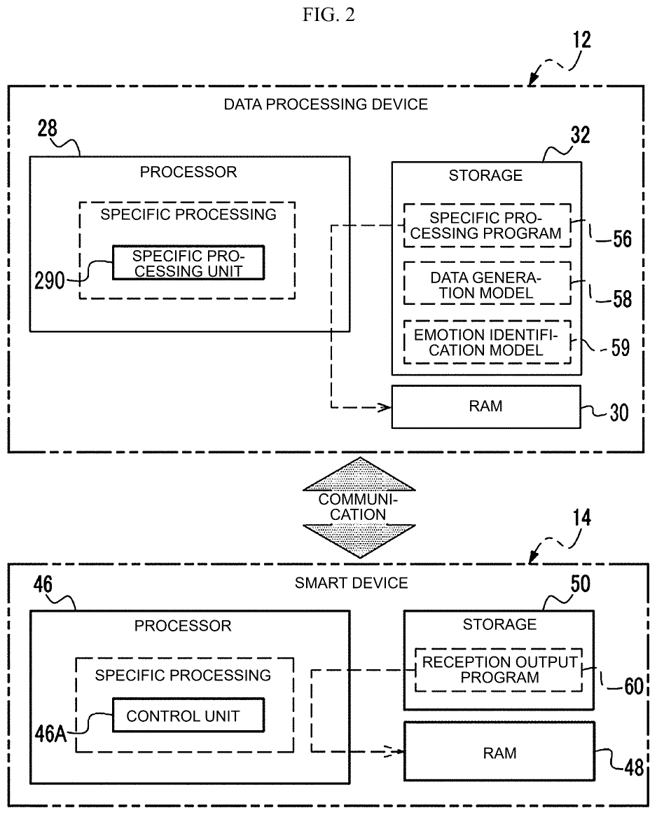

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described comprehensively and in detail at random, further enhancing specificity.

The system of the present invention automatically monitors and manages a health condition and a daily activity status of a resident on a 24-hour basis in an elderly facility such as a nursing home, enables early discovery of an abnormality and a prompt response, and is realized by a cooperative operation of a server and a terminal. The system is composed of a plurality of functional units such as a camera information acquisition unit, a biological information acquisition unit, an abnormality detection and notification unit, a management screen display unit, a data accumulation unit, a communication unit, a user authentication unit, and a privacy protection unit. Specifically, the present system does not merely collect and display information, but adopts a distributed processing architecture that dynamically allocates computing resources distributed between an edge device and a cloud server. The present system containerizes each functional unit as a microservice. The present system automatically scales out computing resources according to a load of each functional unit using a container orchestration technology. The present system thereby dramatically improves a processing speed of the entire system. The present system causes the camera information acquisition unit and the biological information acquisition unit to function as edge nodes. The present system executes primary noise removal and feature amount extraction on raw data acquired at the edge nodes. The present system transmits only the extracted lightweight feature amount vector to the server via the communication unit. The present system significantly reduces consumption of a network bandwidth by this edge computing method. The present system minimizes a communication delay. The present system executes a complex vector operation in a high-dimensional space in the abnormality detection and notification unit arranged on the server side. The present system thereby detects a minute abnormality sign, which is impossible by human visual monitoring, in real time. The present system constructs a time-series database in the data accumulation unit. The present system optimizes a data read/write speed utilizing an in-memory cache. The present system push-delivers a latest analysis result to the management screen display unit without delay using asynchronous communication. The present system executes a hardware-level encryption processing in the user authentication unit and the privacy protection unit. The present system thereby maintains high security in all processes of data processing. The present system reduces a false alarm rate compared to a conventional rule-based monitoring system by these technical improvements. The present system simultaneously ensures scalability at a time of large-scale deployment of the system. The present system reduces a physical patrol burden on a staff in a specific application field of a watching business in an elderly facility. The present system improves data processing efficiency and resource management capability of computer technology itself.

First, the camera information acquisition unit will be described. A plurality of cameras are installed in all places such as a private room of each resident, a corridor, a dining room, a toilet, a bathroom, a living room, a lounge, a rehabilitation space, an entrance, and a vicinity of an emergency exit in the facility. These cameras are installed by combining various types such as a fixed type, a movable type, a wide-angle type, an infrared type, and a night vision type, making it possible to acquire clear video data day and night. For example, at night, an infrared camera or a night vision camera is used to accurately capture a movement of the resident even in a state where lighting is turned off. For example, in a place requiring privacy consideration such as a bathroom or a toilet, face recognition or mosaic processing is executed in real time to extract only minimum necessary information. Video data is acquired by a camera main body or a local terminal, and transmitted to the server via a network. The video data is subjected to image recognition processing by generative AI on the server. The generative AI combines various algorithms such as skeleton estimation, motion classification, object detection, face recognition, posture estimation, gesture recognition, and facial expression analysis to determine extremely diverse actions and states with high accuracy, such as walking, a fall, a sitting posture, a standing posture, an eating action, an excretion action, a sleeping posture, wandering, a motionless state, a rehabilitation exercise, a fall predictive action, abnormal staggering, a rapid posture change, leaving a bed, a wheelchair usage status, a cane or walker usage status, contact with another person, and an operation stop after a fall. For example, in a case of a fall, a rapid posture change, contact with a floor, a state of not moving for a certain period of time, contact with a surrounding object, a staggering action before a fall, and the like are compositely analyzed to distinguish it from normal sitting down or lying down. For example, in a case of an eating action, a hand movement in a dining room, a movement to a mouth, a tableware usage status, a meal time zone, an estimation of a meal amount, the number of chews during a meal, a swallowing action, and the like are determined from a plurality of feature amounts. For example, wandering at night or leaving a bed is also detected as an abnormal action in combination with time information, a life pattern of the resident, and a past action history. For example, in a rehabilitation space, the generative AI can evaluate an implementation status of a rehabilitation exercise or whether an exercise is performed in a correct form in real time, and provide feedback to a staff or a family member. Specifically, the present camera information acquisition unit executes advanced preprocessing and analysis by artificial intelligence on the acquired video data. The present camera information acquisition unit continuously acquires an RGB image tensor having a frame rate of 30 fps and a resolution of 1920×1080 pixels from each camera. The present camera information acquisition unit executes normalization processing and resize processing on this image tensor. The present camera information acquisition unit inputs the preprocessed image tensor to a three-dimensional convolutional neural network that extracts spatiotemporal features. Input data to the present neural network is a five-dimensional tensor of a batch size, the number of frames, the number of channels, a height, and a width. As specific examples of the input data to the present neural network, there are a 90-frame continuous image tensor including an action for the past 3 seconds, and a 1-channel grayscale image tensor acquired from an infrared camera. The present neural network simultaneously extracts a spatial shape feature and a temporal movement feature from the input tensor. The present neural network inputs the extracted feature amounts to a fully connected layer. The present neural network generates a probability distribution vector indicating a probability of belonging to each action class as output data. As specific examples of the output data from the present neural network, there are a numerical vector indicating a walking probability of 0.1, a fall probability of 0.85, and a sitting probability of 0.05, and an array of floating-point numbers indicating three-dimensional coordinates of skeleton keypoints. The present camera information acquisition unit transfers this output result to a subsequent processing module. The present subsequent processing module generates an abnormality detection flag when the output probability score exceeds a preset dynamic threshold value. The present subsequent processing module transmits this abnormality detection flag to the abnormality detection and notification unit of the server. The present system further executes a Transformer-based video analysis model in parallel. The present system concentrates computing resources on an important region in a video using an attention mechanism. The present system thereby separates and recognizes an action of each resident with high accuracy even in a complex scene where a plurality of people cross each other. The present system continuously updates a weight parameter of the model using an error backpropagation method. The present system executes transfer learning using environment data specific to the facility. The present system thereby improves generalization performance for an unknown abnormal action. By these non-conventional procedures, the present system not only imitates human visual information processing but also realizes computer-specific high-accuracy image recognition through a mathematical operation in a high-dimensional space. The present system exhibits technical effects of improving analysis accuracy and reducing a processing delay in specific application fields of fall detection and rehabilitation evaluation.

Next, the biological information acquisition unit will be described. Each resident is made to wear various wearable terminals such as a wristband type, a pendant type, a clothing-integrated type, a skin-attached type, a shoe-built-in type, and an ear-hook type. These terminals are equipped with a heart rate sensor, a body temperature sensor, a blood pressure sensor, a blood oxygen concentration sensor, a respiration sensor, an acceleration sensor, a gyro sensor, a skin potential sensor, a sweating sensor, a position information sensor, an environment sensor (temperature, humidity, illuminance, noise, etc.), and the like. For example, the wristband type terminal constantly measures a heart rate, a body temperature, acceleration, and a blood oxygen concentration, the pendant type terminal detects an impact at a time of a fall and measures a respiration rate, and the clothing-integrated type terminal acquires a body surface temperature and a posture change with high accuracy. The terminal transmits data to a gateway terminal in the facility or directly to the server using various wireless communication methods such as Bluetooth, Wi-Fi, LPWA, ZigBee, and LTE. For example, even if the resident moves within the facility, stable data communication is maintained via a plurality of access points and relays. On the server side, biological information is accumulated in chronological order for each resident and provided for analysis by the generative AI. For example, an abnormality sign is detected by combining a plurality of biological indicators such as an abnormal rise or drop in a heart rate, a rapid body temperature change, a blood oxygen concentration drop, long-time inactivity, frequent waking up at night, a respiration rate abnormality, an impact waveform at a time of a fall, a walking speed drop, a stride change, a posture collapse, a skin potential change, an increase in a sweating amount, and a correlation with an environmental factor. For example, the generative AI comprehensively analyzes multivariate data, such as an infectious disease risk when a body temperature rise and a heart rate rise occur simultaneously, a respiratory disease risk when a blood oxygen concentration drop and a respiration rate increase occur simultaneously, and a severe fall risk when an acceleration waveform at a time of a fall and a sudden heart rate change occur simultaneously. Specifically, the present biological information acquisition unit integrally processes asynchronous and heterogeneous time-series data output from various sensors. The present biological information acquisition unit acquires biological information such as a heart rate, acceleration, and a skin potential as time-series array data from each wearable terminal. The present biological information acquisition unit executes high-frequency noise removal processing using a low-pass filter on this time-series array data. The present biological information acquisition unit divides continuous data into segments of a certain time using a sliding window method. The present biological information acquisition unit inputs the divided data to a long short-term memory network. Input data to the present network is a three-dimensional tensor of a batch size, the number of time steps, and the number of sensor channels. As specific examples of the input data to the present network, there are a 4-channel time-series tensor including a heart rate and 3-axis acceleration for the past 60 seconds, and a 2-channel time-series tensor including an environmental temperature and a body surface temperature. The present network executes a gate operation by combining a past hidden state vector and a current input vector. The present network learns a long-term dependency hidden in the time-series data. The present network generates a continuous value of a risk score indicating a current health condition of the resident or a binary label indicating an abnormal state as output data. As specific examples of the output data from the present network, there are a floating-point number in a range of 0.0 to 1.0 indicating an infectious disease risk, and an integer value of 0 or 1 indicating presence or absence of a fall. The present biological information acquisition unit transfers this output result to a subsequent processing module. The present subsequent processing module calculates a differential value of the output risk score. The present subsequent processing module executes immediate alert issuance processing when detecting a rapid rise in the score. The present system further extracts a local feature pattern from an electrocardiogram waveform or an acceleration waveform using a one-dimensional convolutional neural network. The present system combines the extracted feature amount with an output of the long short-term memory network. The present system executes a final abnormality determination through a fully connected layer. The present system optimizes learning of a model using a cross-entropy error function. The present system applies addition of minute Gaussian noise to time-series data or time warping as a data augmentation method. The present system thereby improves robustness of the model against individual differences of sensors and variations in wearing states. By these processings, the present system eliminates conventional rule-based processing of a single threshold value determination. The present system dynamically evaluates a correlation of multivariate data in a high-dimensional space. The present system exhibits technical effects of reducing false detections and early discovering a minute abnormality sign in specific application fields of early discovery of an infectious disease and detection of sleep apnea syndrome at night.

The abnormality detection and notification unit will be described. It operates on the server and analyzes all data obtained from the camera information acquisition unit and the biological information acquisition unit in real time by the generative AI. The generative AI also learns past data, general medical knowledge, a tendency for each facility, a life pattern for each resident, a seasonal variation, an environmental factor, a drug administration history, a pre-existing disease, allergy information, a family history, a lifestyle habit, a rehabilitation history, a meal history, and the like, and automatically generates and adapts an optimal abnormality detection algorithm for each resident. For example, when a certain resident usually has a high heart rate, an abnormality threshold value is automatically adjusted in consideration of a baseline of the individual. For example, in fall detection, motion analysis of a camera video and acceleration data of a wearable terminal are combined, and a highly accurate fall determination is performed only when both match. For example, when a motionless state at night continues for a long time, the generative AI contextually determines whether it is during sleep or a consciousness disorder, and notifies a staff as necessary. For example, when a plurality of abnormalities occur simultaneously (such as a fall+a heart rate abnormality+a respiration rate abnormality), a severity level is automatically determined, and a medical staff or a family member is immediately notified. For example, at a time of an abnormality occurrence, a latest action history, a vital transition graph, a video clip, a comparison result with a past similar case, a recommended response procedure, and the like are also automatically generated and included in notification details. Specifically, the present abnormality detection and notification unit adopts a multimodal artificial intelligence architecture to execute integrated analysis of heterogeneous data. The present abnormality detection and notification unit receives a video feature amount vector output from the camera information acquisition unit and a biological information feature amount vector output from the biological information acquisition unit. The present abnormality detection and notification unit combines these vectors to generate a single integrated feature amount vector. The present abnormality detection and notification unit inputs this integrated feature amount vector to a multilayer perceptron. Input data to the present multilayer perceptron is, for example, a 768-dimensional numerical vector in which a 512-dimensional video feature amount and a 256-dimensional biological information feature amount are combined. As specific examples of the input data to the present multilayer perceptron, there are a vector in which a video feature amount indicating a fall action and an acceleration feature amount indicating an impact are combined, and a vector in which a video feature amount indicating a motionless state during sleep and a biological information feature amount indicating a normal heart rate are combined. The present multilayer perceptron executes a matrix operation using a nonlinear activation function in a plurality of hidden layers. The present multilayer perceptron generates a continuous value score indicating a severity level of an abnormality and a One-hot vector indicating an abnormality category as output data. As specific examples of the output data from the present multilayer perceptron, there are a floating-point number of 0.92 indicating a severity level, and an array in which only an element corresponding to a fall category is 1 and others are 0. The present abnormality detection and notification unit transfers this output result to a subsequent processing module. The present subsequent processing module determines a notification level based on the output severity score and abnormality category. The present subsequent processing module dynamically routes an optimal notification destination according to the determined notification level. The present system further automatically constructs a baseline of a normal life pattern for each resident using self-supervised learning. The present system executes processing of compressing input data into a low-dimensional latent space and restoring it again using an autoencoder. The present system calculates a reconstruction error between the input data and the restored data. The present system determines that an unknown abnormality has occurred when this reconstruction error exceeds a statistical allowable range. The present system thereby maintains high detection capability even for a new abnormality pattern that is not defined in advance. By these processings, the present system eliminates simple rule-based processing such as a mere logical product or logical sum of a video and biological information. The present system evaluates a nonlinear interaction of feature amounts in a high-dimensional space. The present system exhibits technical effects of realizing a contextual determination and dramatically reducing a false alarm rate in a specific application field of severity level determination when a plurality of abnormalities occur simultaneously.

When an abnormality is detected, the abnormality detection and notification unit immediately notifies a terminal (a smartphone, a tablet, a personal computer, a wearable display, etc.) of a care staff or a medical staff of abnormality details from the server by various methods such as a push notification, an alert sound, a vibration, an email, an automatic call by voice synthesis, and an interactive notification by a chatbot. The notification details include a name of the resident, a type of abnormality (a fall, a heart rate abnormality, a body temperature abnormality, wandering, a motionless state, respiratory arrest, a seizure, a fall sign, etc.), an occurrence place, an occurrence time, latest vital data, a video thumbnail and analysis result, a recommended response procedure, an urgency level, a past similar case, contact information to a medical institution, a contact status to a family member, and the like. For example, when a fall is detected, an immediately preceding value of a heart rate or a body temperature and an action history before and after the fall are also notified together with a video clip of a moment of the fall. For example, in a case of a heart rate abnormality, a heart rate transition graph for the past 24 hours, a medication history, and pre-existing disease information are also attached. Furthermore, when a severity level of the abnormality is high (for example, unconsciousness after a fall, cardiac arrest, respiratory arrest, etc.), the server automatically notifies a family member of a registered emergency contact of necessary information by SMS, an email, an automatic voice call, a dedicated app notification, a chatbot notification, or the like. For example, a message such as “Mr./Ms. XX fell at XX:XX today, and a staff is currently responding. Please contact XX for the facility” is transmitted to the family member. For example, when the family member uses a dedicated app, a dashboard screen capable of confirming a state of the resident and a response status in real time is also provided. Specifically, the present abnormality detection and notification unit dynamically generates a notification message optimized for a situation utilizing a large language model. The present abnormality detection and notification unit inputs an abnormality determination result and related context data to the large language model. Input data to the present large language model is a structured prompt including an abnormality category, an occurrence time, a numerical vector of vital data, and a past response history text. As specific examples of the input data to the present large language model, there are a prompt combining a fall detection flag, a numerical value of a heart rate of 120, and a text history of complaining of dizziness in the past, and a prompt combining a night wandering flag, current position coordinates, and a medical history of dementia. The present large language model analyzes a context of the input prompt using a decoder block of a Transformer architecture. The present large language model calculates a relevance between respective input elements by a self-attention mechanism. The present large language model generates structured notification message data in a JSON format and a text character string for voice synthesis as output data. As specific examples of the output data from the present large language model, there are a JSON object having an urgency level, a recommended action, and a summary text as keys, and a natural language text for reading aloud transmitted to an automatic voice call system. The present abnormality detection and notification unit transfers this output result to a subsequent processing module. The present subsequent processing module inputs the generated text character string to a voice synthesis engine to generate voice waveform data close to a human voice. The present subsequent processing module push-transmits the generated JSON data to the terminal of the staff via an HTTP protocol or an MQTT protocol. The present system further provides a chatbot interface, and executes processing in which the large language model generates a response in real time to a query for additional information in a natural language from the staff. The present system fine-tunes the model using reinforcement learning with a read rate of a notification and a time until completion of a response as a reward. The present system thereby continuously improves conciseness and accuracy of the notification details. By these processings, the present system improves a conventional notification system that transmits a fixed-format boilerplate text. The present system realizes adaptive information transmission according to a situation of a receiver and a nature of an abnormality. The present system exhibits technical effects of preventing an information transmission delay and optimizing a response action in specific application fields of cooperation among staffs in an emergency and a prompt report to a family member.

The management screen display unit will be described. It operates on the server and is accessible by a facility staff from a terminal (a personal computer, a tablet, a smartphone, etc.). On this management screen, current activity statuses (walking, sleeping, eating, excreting, motionless, undergoing rehabilitation, going out, having a visitor, etc.) of all residents, latest vital data, past abnormality occurrence histories, response statuses, notification histories, staff response histories, family contact histories, rehabilitation implementation statuses, meal intake statuses, medication statuses, life pattern analyses, abnormality tendency analyses, risk predictions by AI, recommended response advices, and the like are displayed in a list in real time. For example, a daily activity summary, a vital transition graph, a detailed log at a time of an abnormality occurrence, a record of a responding staff, a contact history to a family member, and the like can also be displayed for each resident. For example, a fall occurrence tendency for the past one week, a night wandering frequency, a transition of a meal intake amount, a rehabilitation implementation rate, a medication compliance rate, and the like are also graphed. For example, a risk prediction and a recommended response advice automatically generated by the AI are also displayed, and can be utilized for judgment support of the staff. The staff can efficiently manage daily health management and a response history at a time of an abnormality occurrence using this screen. Specifically, the present management screen display unit establishes full-duplex communication using WebSocket between a front-end terminal and a back-end server to execute real-time synchronization of data. The present management screen display unit inputs a time-series vector of latest vital data and an activity history aggregated on the server side to a risk prediction model by artificial intelligence. Input data to the present risk prediction model is a multidimensional tensor including a statistical value of vital data for the past one week, an array of sleep times, and a numerical vector of a meal intake amount. As specific examples of the input data to the present risk prediction model, there are a 7-dimensional vector indicating a transition of a daily average heart rate, and an integer array indicating the number of awakenings at night. The present risk prediction model divides an input feature amount space and calculates a predicted value using a gradient boosting decision tree algorithm. The present risk prediction model generates a probability score that a specific health risk will occur within the next 24 hours and a text list of recommended response actions as output data. As specific examples of the output data from the present risk prediction model, there are a floating-point number of a fall probability of 0.75, and an array of text character strings prompting hydration. The present management screen display unit transfers this output result to a subsequent processing module. The present subsequent processing module dynamically renders a color and an icon of a user interface element on a front-end screen based on the output probability score. The present system further minimizes a redraw area of the screen using a virtual DOM technology. The present system thereby suppresses memory consumption of a browser and maintains smooth operability even under a situation where a large amount of data is frequently updated. The present system extracts an important topic from a past staff response history or abnormality occurrence log using a natural language processing model to automatically generate a summary text. The present system displays the generated summary text on a widget on a dashboard. By these processings, the present system eliminates a conventional display method of merely listing search results of a database. The present system converts a huge amount of multimodal data into a visually and intuitively understandable format. The present system exhibits technical effects of reducing a cognitive load on a staff and speeding up data-based decision making in specific application fields of daily health management business and shift handover business by a facility staff.

The data accumulation unit will be described. It securely stores all video data, vital data, abnormality detection histories, notification histories, staff response histories, family contact histories, rehabilitation histories, meal histories, medication histories, life pattern analysis results, AI analysis results, and the like on the server for a long period of time. For example, a past fall case can be searched, and a video and vital data can be matched and re-verified. For example, detailed data can be promptly presented at a time of an inquiry from a family member or a report to an administration. For example, an abnormality tendency analysis and a risk prediction report automatically generated by the AI are also stored, and can be utilized for facility operation, medical cooperation, and family explanation. Specifically, the present data accumulation unit realizes high-speed reading/writing of large-scale data and secure long-term storage by combining a distributed database system and a time-series database. The present data accumulation unit receives a multimodal data record with a time stamp transmitted from each functional unit. The present data accumulation unit adds a signature for falsification detection using a hash function to this data record. The present data accumulation unit inserts the data record to which the signature is added into the time-series database. Input data to the present data accumulation unit is a composite data structure including a binary chunk of video data, a numerical array of vital data, and a JSON object of an AI analysis result. As specific examples of the input data to the present data accumulation unit, there are a record including a 10-second video file path and an average heart rate associated with a specific time stamp, and a record including a severity score and a notification history at a time of abnormality detection. The present data accumulation unit constructs a B-tree index and an inverted index for metadata of the data record. The present data accumulation unit generates a list of data records matching a condition as output data when receiving a search query. As specific examples of the output data from the present data accumulation unit, there are an array of a record group corresponding to a fall case for the past one month, and a set of time-series data points indicating a vital transition of a specific resident. The present data accumulation unit transfers this output result to a subsequent processing module. The present subsequent processing module supplies the extracted record group to a relearning pipeline of an artificial intelligence model. The present system further adopts a tiered data management architecture of cold storage and hot storage. The present system executes high compression processing using a Zstandard algorithm on an old data block whose access frequency has decreased. The present system asynchronously transfers the compressed binary file to inexpensive object storage. By these processings, the present system improves a conventional method of merely storing data in a file server. The present system optimizes consumption of a storage capacity while cryptographically guaranteeing integrity of data. The present system exhibits technical effects of maintaining high-speed search performance of large-scale data and minimizing a data storage cost in specific application fields of re-verification of a past abnormality case and an audit report to an administration.

The communication unit will be described. Communication among a camera, a wearable terminal, a staff terminal, a family terminal, and the server is realized by combining various methods such as Wi-Fi, LTE, 5G, LPWA, ZigBee, Bluetooth, VPN, and encrypted communication. For example, at a time of a network failure in the facility, it automatically switches to a backup line to prevent data loss and a notification delay. For example, all communication data is encrypted to prevent unauthorized access and information leakage by a third party. Specifically, the present communication unit dynamically controls a communication protocol stack and a network route using a software-defined network technology. The present communication unit periodically collects numerical data of a network delay time, a packet loss rate, and a bandwidth usage rate from each node on a network. The present communication unit inputs this numerical data to a reinforcement learning-based routing optimization model. Input data to the present optimization model is a state vector indicating a current state of each communication link. As specific examples of the input data to the present optimization model, there are a numerical array indicating that a delay of a Wi-Fi link is 50 milliseconds and a packet loss is 2 percent, and numerical data indicating that a bandwidth usage rate of an LTE link is 80 percent. The present optimization model predicts future deterioration of communication quality and calculates an optimal action value using a Q-learning algorithm. The present optimization model generates an identifier of an optimal communication route and a control parameter of a data compression rate as output data. As specific examples of the output data from the present optimization model, there are an update command of a routing table instructing switching to a 5G network which is a backup line, and a control flag for halving a bit rate of video data. The present communication unit transfers this output result to a subsequent processing module. The present subsequent processing module executes processing of seamlessly switching traffic to the selected route. The present system further executes end-to-end encryption processing using an AES-256 algorithm and a TLS 1.3 protocol on all communication payloads. The present system performs secure exchange of a session key using a public key cryptography method. The present system adds a time stamp and a sequence number to header information of a packet to prevent a replay attack. By these processings, the present system eliminates a conventional network management method depending on a static routing setting. The present system autonomously adapts to a fluctuation of a network environment. The present system exhibits technical effects of completely preventing data loss and guaranteeing secure data transmission in specific application fields of backup at a time of a communication failure in the facility and data transmission to a family member via an external network.

The user authentication unit will be described. When a staff or a family member accesses the management screen or the dedicated app, a multi-layered authentication method such as ID/password authentication, biometric authentication, two-step authentication, terminal authentication, and access authority management is introduced to ensure security. For example, an access authority is finely set for each role, such as allowing only a medical staff to browse details of vital data and correct an AI analysis result. Specifically, the present user authentication unit executes multi-factor authentication and dynamic access control based on a zero-trust security model. The present user authentication unit acquires biological information data and context data from a terminal of a user attempting to log in. The present user authentication unit inputs this data to a feature amount matching model using a Siamese network. Input data to the present matching model is a pixel tensor of a face image acquired from a camera and a context vector including an IP address and position information of the terminal. As specific examples of the input data to the present matching model, there are an RGB face image tensor having a resolution of 224×224, and a character string array including a MAC address of an access source and time information. The present matching model converts an input image and a registered template image on a database into high-dimensional feature vectors, respectively, using two convolutional neural networks having the same structure. The present matching model calculates a cosine similarity between the two feature vectors. The present matching model generates a similarity score and a binary flag indicating authentication success or failure as output data. As specific examples of the output data from the present matching model, there are a floating-point number of a similarity of 0.98, and a Boolean value of True indicating authentication success. The present user authentication unit transfers this output result to a subsequent processing module. The present subsequent processing module generates an access token in a JSON Web Token format when receiving the authentication success flag. The present subsequent processing module embeds fine-grained access authority information according to a role of the user in this token. The present system further continuously monitors an operation behavior of the user during a session. The present system executes continuous authentication by inputting a keystroke timing and a mouse movement trajectory to a recurrent neural network. The present system forcibly terminates the session and requests re-authentication when a behavior score falls below a threshold value. By these processings, the present system eliminates a conventional static authentication method depending on a single password. The present system compositely evaluates a biometric feature and a behavioral feature of the user in a high-dimensional space. The present system exhibits technical effects of preventing a spoofing attack and strictly protecting system resources in specific application fields of browsing of highly confidential vital data by a medical staff and remote access from the outside.

The privacy protection unit will be described. For personal information such as camera video, vital data, and an action history, various privacy protection measures such as an anonymization process, a masking process, access log management, clarification of a data use purpose, acquisition of user consent, and restriction on provision to a third party are taken. For example, when providing data to a family member or an external medical institution, consent of the person is acquired, and only minimum necessary information is provided. For example, it is also possible to set the video data to be automatically deleted after a certain period of time has elapsed. Specifically, the privacy protection unit executes the data masking and the anonymization process in real time on an edge device and a server. The privacy protection unit inputs a video stream output from the camera information acquisition unit to a semantic segmentation model. Input data to the segmentation model is a continuous RGB image tensor. As a specific example of the input data to the segmentation model, there is an image frame with a resolution of 640×480 acquired from a camera installed in a bathroom or a toilet. The segmentation model executes class classification in units of pixels using a U-Net architecture. The segmentation model generates a binary mask tensor indicating a person region and a tensor indicating a background region as output data. As a specific example of the output data from the segmentation model, there is a two-dimensional array in which a pixel value of a silhouette portion of a person is 1 and the others are 0. The privacy protection unit transfers this output result to a subsequent processing module. The subsequent processing module executes a Gaussian blur process or a pixel replacement process on a region where the binary mask tensor indicates 1. The subsequent processing module generates an anonymized video stream in which an individual cannot be identified. The system further applies a k-anonymization algorithm and a differential privacy technology to structured data of the vital data and the action history. The system reduces identifiability of individual records by adding Laplace noise to a dataset. The system records a request source IP, a user ID, an access date and time, and operation details for all data access requests in a blockchain-based tamper-proof ledger using an access log management module. By these processes, the system improves a conventional physical privacy protection method that merely conceals data. The system mathematically removes superficial visual information capable of identifying an individual while maintaining an abstract feature amount such as a skeletal movement and a posture change necessary for abnormality detection. The system exhibits a technical effect of achieving both protection of a privacy right and data utilization in a specific application field of a status report to a family member and data provision to an external medical institution.

Utilization of the generative AI is essential in each unit. In the camera information acquisition unit, highly accurate discrimination of a complex action and an abnormality, which has been difficult with a conventional rule base or simple moving object detection, is realized using an image recognition and action classification model by the generative AI. For example, a fall sign action, a slight stagger, a simultaneous action of a plurality of persons, contact with an object, a facial expression change, gesture recognition, and the like are also discriminated with high accuracy. In the biological information acquisition unit, time-series data analysis and abnormality pattern generation by the generative AI, automatic baseline learning for each individual, complex health risk estimation by simultaneous analysis of a plurality of indices, automatic correction of a seasonal variation and an environmental factor, and the like are performed. In the abnormality detection and notification unit, multivariate data integrated analysis by the generative AI, abnormality degree scoring, automatic generation of notification details, severity determination, automatic selection of a notification destination, automatic generation of a recommended response procedure, similarity search with a past case, cooperation with a medical knowledge base, and the like are realized. In the management screen display unit, data visualization by the generative AI, automatic summarization of an abnormality tendency, advice generation for a staff, risk prediction, life pattern analysis, rehabilitation evaluation, eating amount estimation, medication compliance rate estimation, and the like are also possible. Specifically, the system introduces a large-scale multimodal Transformer architecture as a foundation model that integrates each functional unit. The system pre-learns a general-purpose feature representation from a huge amount of unlabeled data using self-supervised learning. The system executes transfer learning using facility-specific data on the pre-learned foundation model. Input data to the foundation model is multimodal sequence data including a video tensor, time-series sensor data, and a text log. As a specific example of the input data to the foundation model, there are a sequence of moving image patches from a camera, a sequence of heart rate fluctuations from a wearable terminal, and a token string of a past staff response record text. The foundation model calculates a correlation between different modalities using a cross-attention mechanism. The foundation model generates a high-dimensional latent representation vector as output data. As a specific example of the output data from the foundation model, there is an array of 1024-dimensional floating-point numbers expressing a comprehensive state of a current resident. The system transfers this output result to a subsequent processing module specific to each task. The subsequent processing module inputs this latent representation vector to a classification head for abnormality detection, a regression head for risk prediction, or a decoder head for text generation. Thereby, the system simultaneously acquires inference results of various tasks from a single foundation model. The system further shares only update information of a weight parameter of the model among a plurality of facilities using a federated learning technology. The system improves generalization performance of the model without taking raw data out of the facility. By these processes, the system eliminates a conventional approach of constructing an individual small-scale model for each task. The system integrally processes a complex interaction between modalities in a high-dimensional space. The system exhibits a technical effect of a dramatic improvement in inference accuracy and a reduction in model development and operation costs in a specific application field of discovery of an unknown abnormality pattern and estimation of a complex health risk.

Summarizing realization of each unit of the system on a server and a terminal, video acquisition of the camera information acquisition unit is performed by a terminal (camera main body), and image recognition and action classification are executed by a server. Sensor data acquisition of the biological information acquisition unit is performed by a terminal (wearable terminal), and data analysis and abnormality detection are executed by the server. The abnormality detection and notification unit operates on the server, and reception of a notification and alert display are performed by a terminal (staff terminal, family member terminal). The management screen display unit operates on the server and is accessed from a terminal (personal computer, tablet, etc.). A data accumulation unit is realized by the server. A communication unit, a user authentication unit, and the privacy protection unit are also mainly realized by the server, but a part of functions can also be provided on the terminal side. Specifically, the system adopts a model split inference architecture that dynamically distributes a calculation load between an edge device and a cloud server. The system deploys a lightweight artificial intelligence model to an edge device such as a camera main body or a wearable terminal. The edge device inputs acquired raw data to the lightweight model and executes primary inference. Input data to the lightweight model is a high-resolution image tensor or high-sampling-rate waveform data directly acquired from a sensor. As a specific example of the input data to the lightweight model, there are an image frame with a 4K resolution captured by a camera and 3-axis acceleration data sampled at 100 Hz. The lightweight model executes an operation using an efficient convolutional architecture such as MobileNet or SqueezeNet. The lightweight model generates a dimension-reduced intermediate feature amount tensor or an initial abnormality candidate flag as output data. As a specific example of the output data from the lightweight model, there are a feature map in which a spatial resolution is compressed and a Boolean value indicating moving object detection. The edge device transmits this output result to the cloud server via the communication unit. The cloud server inputs the received intermediate feature amount tensor to a large-scale secondary inference model. The secondary inference model executes final highly accurate inference using a network having a complex attention mechanism or a deep layer. The secondary inference model generates a final inference result vector as output data. As a specific example of the output data from the secondary inference model, there are a probability distribution of a detailed action category and an integrated health risk score. The cloud server transfers this output result to a subsequent processing module and executes a state update process of the entire system. The system monitors a network bandwidth and a server load status, and dynamically changes a split point of the model between the edge and the server. By these processes, the system eliminates a bottleneck of a conventional centralized process in which all raw data is transmitted to a server. The system exhibits a technical effect of saving a communication bandwidth and minimizing an inference latency in a specific application field of abnormality detection requiring real-time performance and monitoring of a large-scale facility.

For example, when a resident falls in a toilet in a facility, a fall action is detected from a camera video, and at the same time, a sudden change in acceleration and a change in a heart rate are detected from a wearable terminal. The generative AI integrally analyzes these pieces of data, increases accuracy of a fall, and immediately notifies a staff terminal. For example, when a resident leaves a bed at night and does not return for a long time, wandering is detected from a camera video and position information of a wearable terminal, and a staff is notified. For example, when a body temperature and a heart rate rise at the same time, the AI estimates an infection risk and issues a notification prompting an early response. For example, even when a family member is in a remote location, a detailed situation is automatically notified to a family member terminal in a case of a serious abnormality. For example, when an exercise in a rehabilitation space is not correctly performed, the AI automatically notifies a staff of advice. For example, when an eating amount tends to decrease, the AI detects a risk at an early stage and alerts a staff and a family member. For example, when forgetting to take medication occurs frequently, the AI automatically calculates a medication compliance rate and transmits a reminder notification to a staff and a family member. For example, when a plurality of abnormalities occur simultaneously, the AI automatically determines a severity and preferentially notifies a medical staff and a family member. For example, the AI predicts a future risk from a past abnormality occurrence tendency and a life pattern, and issues an advance warning to a staff. Specifically, the system executes probabilistic inference by a vector operation in a high-dimensional space instead of a rule-based conditional branch in these use cases. In fall detection in a toilet, the system inputs a time-series sequence of skeletal keypoint data extracted from a camera video and acceleration waveform data extracted from a wearable terminal to a multimodal AI model. As a specific example of input data to the AI model, there are a time-series change of three-dimensional coordinates indicating a joint position of a human body and a numerical array indicating a sudden fluctuation of an acceleration vector with respect to a gravity direction. The AI model synchronizes these pieces of input data in time and calculates cross-attention. The AI model generates a probability distribution vector of each abnormality scenario as output data. As a specific example of the output data from the AI model, there is a numerical vector indicating a mere squatting probability of 0.1, a fall probability of 0.88, and a sensor noise probability of 0.02. The system transfers this output result to a subsequent processing module. The subsequent processing module executes an immediate alert generation process when the fall probability exceeds a dynamic threshold value. In estimation of an infection risk, the system inputs time-series data of a body temperature and a heart rate to a Transformer-based prediction model. The prediction model compares a baseline of a past healthy state with current input data, and extracts a slight rising trend. The prediction model generates a predicted probability score of infection onset as output data. In detection of forgetting to take medication, the system integrally analyzes a recognition result of an eating action from a camera video and opening/closing sensor data of a medication box. The system calculates a numerical value of a medication compliance rate as output data and uses it as a trigger for a reminder notification. By these processes, the system eliminates a conventional detection method with many false alarms depending on a single sensor threshold value. The system mathematically models a causal relationship of a plurality of events. The system exhibits a technical effect of accurate grasping of a complex event and a dramatic reduction in false detection in a specific application field of wandering detection at night and form evaluation of rehabilitation.

As described above, the embodiment of the present invention comprehensively and practically realizes health management, safety management, information sharing, work efficiency improvement, privacy protection, risk prediction, and family member cooperation in an elderly facility such as a nursing home by a cooperative operation of a server and a terminal, multilayered utilization of generative AI, and cooperation of various functional units such as a camera, a wearable terminal, a management screen, communication, authentication, and privacy protection, and is an extremely useful system that comprehensively solves various problems that have been difficult with conventional technology. Specifically, the system functions as a self-evolving computer system integrating efficient utilization of a hardware resource and a continuous learning pipeline of a model. The system constructs a parallel operation cluster using a GPU on a server side, and processes a huge tensor operation at high speed. The system accumulates new sensor data collected during operation and feedback of a response result by a staff as a dataset with a correct answer label. The system inputs this dataset to a relearning pipeline. Input data to the relearning pipeline is batch data including a tensor of a falsely detected video clip and a vital data array of a missed abnormality. As a specific example of the input data to the relearning pipeline, there are a video tensor of a transfer action to a wheelchair falsely recognized as a fall, and labeling data of “normal” by a staff for it. The system calculates a weight parameter matrix of a neural network using a backpropagation method and optimizes it by a gradient descent method. The system generates an updated weight parameter matrix of the neural network as output data. As a specific example of the output data from the system, there is binary data of a new weight file consisting of millions of floating-point numbers. The system transfers this output result to a subsequent processing module. The subsequent processing module executes a process of packaging the updated model as a container image and deploying it to each edge device and server without downtime. The system further autonomously optimizes a resource allocation policy of the entire system using reinforcement learning. By these processes, the system improves a conventional static software system fixed at performance at a time of introduction. The system dynamically adapts to a change in an operation environment and an unknown event. The system exhibits a technical effect of long-term accuracy improvement by self-evolution of the system and continuous reduction in an operation cost in a specific application field of comprehensive health management and work efficiency improvement in an elderly facility.

### System Configuration

The system according to the present embodiment includes a camera information acquisition unit, a biological information acquisition unit, an abnormality detection and notification unit, a management screen display unit, a data accumulation unit, a communication unit, a user authentication unit, a privacy protection unit, and a generative AI cooperation unit. The camera information acquisition unit has a function of acquiring clear video data day and night from cameras such as a fixed type, a movable type, a wide-angle type, an infrared type, and a night vision type installed in various places such as a private room, a corridor, a dining room, a toilet, a bathroom, a living room, a lounge, a rehabilitation space, an entrance, and a vicinity of an emergency exit in an elderly facility such as a nursing home. For example, at night, an infrared camera or a night vision camera is used to accurately capture a movement of a resident even in a state where lighting is turned off, and in a place requiring privacy consideration such as a bathroom or a toilet, face recognition or a mosaic process is executed in real time to extract only minimum necessary information. Furthermore, in a rehabilitation space, an implementation status of a rehabilitation exercise and whether an exercise is performed in a correct form are discriminated from a video, and in a dining room, an eating action and an eating amount are estimated, and the number of chews and a swallowing action are also detected. The video data acquired by the camera information acquisition unit is transmitted to a server via a network, and is subjected to image recognition processing by the generative AI cooperation unit. Specifically, the generative AI cooperation unit applies a hybrid architecture of a batch process and a stream process to the video data transmitted from the camera information acquisition unit. The generative AI cooperation unit inputs synchronized video stream tensors from a plurality of cameras to a ring buffer on a memory. Input data to the cooperation unit is a four-dimensional tensor including an identifier of each camera, a time stamp, and an RGB pixel value. As a specific example of the input data to the cooperation unit, there is a video frame group with a resolution of 1280×720 simultaneously acquired from three cameras installed in a dining room. The cooperation unit applies a hybrid network combining a two-dimensional CNN for spatial feature extraction and an RNN for temporal feature extraction to this input tensor. The network generates a heat map matrix of a spatial and temporal abnormality score as output data. As a specific example of the output data from the network, there is a two-dimensional array expressing an abnormality occurrence probability in each pixel region in a video by a grayscale value from 0 to 255. The cooperation unit transfers this output result to a subsequent processing module. The subsequent processing module specifies coordinates of a region requiring attention having a high score on the heat map. The subsequent processing module generates a control command for dynamically increasing an automatic zoom process for the corresponding region or a frame rate of the camera. The system further executes a process of reconstructing a clear video tensor from a noisy video tensor acquired in a low illuminance environment using a generative adversarial network. By these processes, the system eliminates a conventional inefficient image analysis method that performs a uniform process on an entire screen. The system dynamically concentrates a calculation resource on a region where a sign of an abnormality exists. The system exhibits a technical effect of optimal allocation of a calculation resource and a dramatic improvement in monitoring accuracy in a specific application field of watching at night and monitoring of a wide shared space.

The biological information acquisition unit has a function of acquiring various biological information such as a heart rate, a body temperature, a blood pressure, a blood oxygen concentration, a respiration rate, an acceleration, a gyro, a skin potential, a sweating amount, position information, and environmental information (temperature, humidity, illuminance, noise, etc.) at regular intervals from a wearable terminal such as a wristband type, a pendant type, a clothing-integrated type, a skin-attached type, a shoe-built-in type, and an ear-hook type worn by each resident. For example, a wristband-type terminal constantly measures a heart rate, a body temperature, an acceleration, and a blood oxygen concentration, a pendant-type terminal detects an impact at a time of a fall and measures a respiration rate, a clothing-integrated terminal acquires a change in a body surface temperature and a posture with high accuracy, and a shoe-built-in terminal detects a walking speed, a stride, and a change in a walking pattern. These terminals transmit data to a gateway terminal in a facility or directly to a server using various wireless communication methods such as Bluetooth, Wi-Fi, LPWA, ZigBee, and LTE. The data acquired by the biological information acquisition unit is used for multivariate analysis and abnormality pattern detection by the generative AI cooperation unit. Specifically, the generative AI cooperation unit executes time synchronization and a resampling process on heterogeneous sensor data transmitted from the biological information acquisition unit. The generative AI cooperation unit inputs asynchronous time-series data of a heart rate and an acceleration having different sampling rates to a preprocessing module. Input data to the preprocessing module is a raw sensor data array including a missing time stamp and jitter. As a specific example of the input data to the preprocessing module, there are an array of heart rate data acquired at 1 Hz and an array of 3-axis acceleration data acquired at 50 Hz. The preprocessing module maps these pieces of data to a common time axis and normalizes them using a spline interpolation algorithm. The preprocessing module generates a multidimensional time-series tensor interpolated and normalized on a common time axis as output data. As a specific example of the output data from the preprocessing module, there is a five-dimensional floating-point tensor in which all sensor values are aligned at uniform intervals of 10 Hz. The cooperation unit transfers this output result to a subsequent processing module. The subsequent processing module inputs this normalized tensor to a Transformer-based time-series prediction model. The prediction model learns a dependency relationship between past long-term data points using a self-attention mechanism. The prediction model predicts a fluctuation trajectory of future vital data. The system further statistically estimates and complements a missing portion of data due to a temporary communication disconnection of a sensor using a Kalman filter. By these processes, the system improves a conventional simple time-series analysis method vulnerable to data missing and asynchrony. The system enables highly accurate feature extraction even from incomplete real environment data. The system exhibits a technical effect of improving robustness against a delay and missing between sensors and stabilizing prediction accuracy in a specific application field of health condition monitoring of a resident using a plurality of wearable terminals together.

The abnormality detection and notification unit has a function of analyzing all data obtained from the camera information acquisition unit and the biological information acquisition unit in real time by the generative AI cooperation unit, and realizing early discovery of an abnormality and a prompt notification to a related person. For example, in fall detection, highly accurate fall determination is performed by combining action analysis of a camera video and acceleration data of a wearable terminal, and an abnormal rise/drop in a heart rate and a body temperature, a blood oxygen concentration drop, an abnormality in a respiration rate, no action or wandering at night, severity determination when a plurality of abnormalities occur simultaneously, and the like are also automatically performed. When an abnormality is detected, abnormality details are immediately notified to a terminal (smartphone, tablet, personal computer, wearable display, etc.) of a care staff or a medical staff by various methods such as a push notification, an alert sound, a vibration, an email, an automatic call by voice synthesis, and an interactive notification by a chatbot. Furthermore, in a case of a serious abnormality, necessary information is also notified to a family member of a registered emergency contact by SMS, an email, an automatic voice call, a dedicated application notification, a chatbot notification, or the like. Notification details include a name of a resident, a type of abnormality, an occurrence place, an occurrence time, latest vital data, a video thumbnail and an analysis result, a recommended response procedure, an urgency level, a past similar case, contact information to a medical institution, a contact status to a family member, and the like. Specifically, the generative AI cooperation unit introduces an ensemble learning method in abnormality detection to improve reliability of determination. The generative AI cooperation unit inputs a vector of an abnormality probability score independently output from each of a model for analyzing a camera video, a model for analyzing vital data, and a model for analyzing environmental data to an aggregation module. Input data to the aggregation module is an array of probability values output from a plurality of independent AI models. As a specific example of the input data to the aggregation module, there is a three-dimensional vector including a fall probability of 0.8 from a video model, an abnormality probability of 0.6 from a vital model, and an abnormality probability of 0.2 from an environmental model. The aggregation module executes a dynamic weighted majority operation on these scores using a gradient boosting algorithm. The aggregation module generates a final abnormality determination flag and a reliability score indicating certainty of the determination as output data. As a specific example of the output data from the aggregation module, there are a Boolean value True indicating an abnormality occurrence and a floating-point number indicating a reliability of 0.95. The cooperation unit transfers this output result to a subsequent processing module. The subsequent processing module executes a human-in-the-loop process of suspending an automatic notification and prompting a human staff to confirm when the reliability score falls below a preset threshold value (for example, 0.7). The system collects a confirmation result of a staff as a correct answer label, and readjusts a weight of each base model of an ensemble model. By these processes, the system solves a problem of conventional technology, which is a false determination caused by a bias or overlearning of a single model. The system mathematically integrates inference results from a plurality of viewpoints. The system exhibits a technical effect of a dramatic improvement in determination accuracy and prevention of a fatal miss in a specific application field of severity determination when a plurality of abnormalities occur simultaneously and an automatic report in an emergency.

The management screen display unit operates on a server, is accessible by a facility staff from a terminal (personal computer, tablet, smartphone, etc.), and has a function of displaying a list of a current activity status of all residents, latest vital data, a past abnormality occurrence history, a response status, a notification history, a staff response history, a family member contact history, a rehabilitation implementation status, an eating status, a medication status, life pattern analysis, abnormality tendency analysis, risk prediction by AI, recommended response advice, and the like in real time. For example, a daily activity summary, a vital transition graph, a detailed log at a time of an abnormality occurrence, a record of a responding staff, a contact history to a family member, and the like can be displayed for each resident, and a fall occurrence tendency in the past week, a wandering frequency at night, a transition of an eating amount, a rehabilitation implementation rate, a medication compliance rate, and the like are also graphed. Risk prediction and recommended response advice automatically generated by the AI are also displayed, and can be utilized for judgment support of a staff. Specifically, the management screen display unit executes an advanced cache control process utilizing an in-memory data store in a back end. The management screen display unit inputs a GraphQL query transmitted from a front-end terminal to a query analysis module. Input data to the query analysis module is a structured text including a type of requested data, a period, and a filter condition. As a specific example of the input data to the query analysis module, there is a query character string requesting a heart rate transition and an abnormality detection log of a specific resident for the past 24 hours. The query analysis module accesses an in-memory data store such as Redis and confirms whether requested data exists in a cache. The query analysis module issues an optimized SQL query to a time-series database and aggregates data when a cache miss occurs. The query analysis module generates a response payload in a JSON format including statistical data of a requested period as output data. As a specific example of the output data from the query analysis module, there is a JSON object including an array of pairs of a time stamp and a heart rate value, and a list of an abnormality occurrence time and a category. The management screen display unit transfers this output result to a subsequent processing module. The subsequent processing module transmits the generated JSON data to the front-end terminal. The front-end terminal updates a state of a component on a virtual DOM using the received data, and executes a high-speed screen drawing process of reflecting only a difference on an actual DOM. The system further parses an inference result of a risk prediction model by the AI in a background without blocking a main thread using a WebWorker. By these processes, the system eliminates an architecture of a conventional synchronous Web application that reloads an entire page. The system asynchronously separates a large amount of data processing and UI drawing. The system exhibits a technical effect of shortening a server response time and maintaining smooth operability of a UI in a specific application field of management work of a large-scale facility accessed by dozens of staffs simultaneously.

The data accumulation unit has a function of securely storing all video data, vital data, abnormality detection histories, notification histories, staff response histories, family contact histories, rehabilitation histories, meal histories, medication histories, life pattern analysis results, AI analysis results, and the like on a server for a long period of time. For example, a past fall case can be searched, and video and vital data can be matched and re-verified, and detailed data can be promptly presented at a time of an inquiry from a family member or a report to an administration. An abnormality tendency analysis and a risk prediction report automatically generated by AI are also stored, and can be utilized for facility operation, medical cooperation, and family explanation. Specifically, the data accumulation unit integrates and executes tiered storage management according to a data lifecycle and an advanced data compression algorithm. The data accumulation unit inputs a block of old log data that has passed a certain period (for example, 30 days) to a compression module. Input data to the compression module is an uncompressed binary data chunk extracted from a time-series database. As a specific example of the input data to the compression module, there is a set of CSV files and JSON files of several gigabytes including vital data and environmental sensor data of all residents for the past one month. The compression module detects and encodes a redundant pattern in the data using a dictionary-based compression algorithm such as LZ4 or Zstandard. The compression module generates a binary file encoded at a high compression rate as output data. As a specific example of the output data from the compression module, there is an archive file compressed to one-tenth of an original size. The data accumulation unit transfers this output result to a subsequent processing module. The subsequent processing module executes a process of asynchronously transferring the compressed file from an expensive high-speed storage to an inexpensive object storage. The system further registers metadata (period, data type, hash value) of the transferred archive file in a distributed hash table. When a search request for past data occurs, the system refers to the distributed hash table to specify a corresponding archive file, executes a decompression process on the fly, and responds to a query. By these processes, the system improves a conventional inefficient data management method of holding all data in a single storage. The system mathematically optimizes a trade-off between data access frequency and storage cost. The system exhibits technical effects of minimizing a data storage cost and maintaining search performance in a specific application field of long-term health data accumulation over several years and management of a dataset for AI model relearning.

The communication unit has a function of realizing communication among a camera, a wearable terminal, a staff terminal, a family terminal, and a server by various methods such as Wi-Fi, LTE, 5G, LPWA, ZigBee, Bluetooth, VPN, and encrypted communication, automatically switching to a backup line in an event of a network failure, and preventing data loss and a notification delay. All communication data is encrypted to prevent unauthorized access and information leakage by a third party. Specifically, the communication unit optimizes data transfer between an edge device and a cloud server. The communication unit analyzes header information of a packet transmitted from each device. The communication unit executes QoS control according to a type of data. The communication unit allocates delay-sensitive data such as vital data and an abnormality detection alert to a highest priority queue. The communication unit allocates large-capacity video data to a background queue. The communication unit dynamically monitors a network bandwidth. The communication unit changes a compression rate of video data in real time according to an available bandwidth. The communication unit adaptively uses TCP and UDP properly as a communication protocol. The communication unit uses TCP for a control command requiring reliable arrival. The communication unit uses UDP for streaming video in which real-time performance is emphasized. The communication unit applies a forward error correction algorithm when a packet loss occurs. The communication unit minimizes a retransmission request. The communication unit transmits a periodic heartbeat signal to detect a network failure. The communication unit activates a failover process when a response delay of a main line exceeds a predetermined threshold value. The communication unit instantaneously switches routing to a backup cellular line. The communication unit adopts an AES 256-bit algorithm for encrypting communication data. The communication unit uses an encryption key dynamically generated for each session. The communication unit executes elliptic curve Diffie-Hellman key exchange as a key exchange protocol. The communication unit completely eliminates a man-in-the-middle attack. The communication unit dramatically improves communication reliability and security by these processes. The communication unit satisfies strict data protection requirements in a medical institution and a nursing facility.

The user authentication unit has a function of introducing a multi-layered authentication method such as ID/password authentication, biometric authentication, two-step authentication, terminal authentication, and access authority management when a staff or a family member accesses a management screen or a dedicated application, and ensuring security. For example, an access authority is finely set for each role, such as allowing only a medical staff to browse details of vital data and correct an AI analysis result. Specifically, the user authentication unit executes strict access control based on a zero trust architecture. The user authentication unit receives a login request. The user authentication unit hashes an input password using a SHA3 algorithm. The user authentication unit collates it with a salted hash value in a database. The user authentication unit requests face authentication or fingerprint authentication as biometric authentication. The user authentication unit inputs a face image tensor acquired from a camera of a terminal to a convolutional neural network. The user authentication unit extracts a 512-dimensional feature vector. The user authentication unit calculates a cosine similarity with a registered feature vector. The user authentication unit determines that the user is the person himself/herself when the similarity exceeds a threshold value. The user authentication unit generates a JSON Web Token after successful authentication. The user authentication unit embeds claim information indicating a user role and an access permission range in the token. The user authentication unit adds an electronic signature to the token. The user authentication unit transmits the token to a client terminal. The user authentication unit verifies validity of the token for each API request from a client. The user authentication unit applies a role-based access control model. The user authentication unit determines presence or absence of an authority for a requested resource. The user authentication unit immediately discards a request without an authority. The user authentication unit records an unauthorized access attempt as a security log. The user authentication unit monitors an abnormal login attempt pattern with a machine learning model. The user authentication unit automatically blocks a brute force attack and a credential stuffing attack. The user authentication unit enhances robustness of the entire system by these processes. The user authentication unit prevents leakage of highly confidential medical data.

The privacy protection unit has a function of taking various privacy protection measures such as an anonymization process, a masking process, access log management, clarification of a data use purpose, user consent acquisition, and a third-party provision restriction for personal information such as camera video, vital data, and an action history. For example, when providing data to a family member or an external medical institution, it is possible to set to acquire consent of the person himself/herself, provide only minimum necessary information, and automatically delete video data after a certain period of time has elapsed. Specifically, the privacy protection unit executes a real-time data obfuscation process on an edge device side. The privacy protection unit inputs an RGB image frame acquired from a camera to a semantic segmentation model. The privacy protection unit specifies a person region in an image in units of pixels. The privacy protection unit applies a Gaussian filter to a face region of the specified person. The privacy protection unit performs an irreversible blurring process. The privacy protection unit extracts only a silhouette of the person. The privacy protection unit generates a binarized mask image from which background information is completely deleted. The privacy protection unit transmits only these anonymized image data to a cloud server. The privacy protection unit also applies a k-anonymity algorithm to biological data. The privacy protection unit generalizes a specific data point leading to identification of an individual. The privacy protection unit records an access history to a database in a blockchain network. The privacy protection unit constructs a tamper-proof audit log. The privacy protection unit operates a timer process for managing a data storage period. The privacy protection unit physically overwrites and deletes data exceeding a set retention period from a storage. The privacy protection unit holds a flag for managing a consent state of data provision in a database. The privacy protection unit refers to the consent flag when receiving a data acquisition request from an external API. The privacy protection unit replaces data of an item for which consent has not been obtained with a null value. The privacy protection unit protects individual dignity by these processes. The privacy protection unit achieves both an advanced monitoring function and privacy protection.

The generative AI cooperation unit has a function of integrating various data obtained from the camera information acquisition unit and the biological information acquisition unit, and realizing various AI processes such as image recognition, action classification, time-series data analysis, abnormality pattern generation, automatic baseline learning for each individual, simultaneous analysis of a plurality of indices, abnormality degree scoring, automatic generation of notification details, severity determination, automatic selection of a notification destination, automatic generation of a recommended response procedure, similarity search with a past case, cooperation with a medical knowledge base, data visualization, automatic summarization of an abnormality tendency, advice generation for a staff, risk prediction, life pattern analysis, rehabilitation evaluation, meal intake estimation, and medication compliance rate estimation. For example, a fall sign action, a slight stagger, a simultaneous action of a plurality of persons, contact with an object, a facial expression change, gesture recognition, and the like are also determined with high accuracy, automatic correction of a seasonal variation and an environmental factor of a body temperature and a heart rate, automatic generation of a recommended response procedure at a time of an abnormality occurrence, and prediction of a future risk from a past abnormality occurrence tendency and a life pattern are performed to give an advance warning to a staff. Specifically, the generative AI cooperation unit adopts a multimodal deep learning architecture. The generative AI cooperation unit simultaneously processes video data and time-series vital data. The generative AI cooperation unit inputs a sequence of video frames to a three-dimensional convolutional neural network. The generative AI cooperation unit extracts spatial and temporal features. The generative AI cooperation unit converts the extracted features into a 512-dimensional video feature vector. The generative AI cooperation unit inputs time-series data such as a heart rate and acceleration to a long short-term memory network. The generative AI cooperation unit learns a time-series dependency. The generative AI cooperation unit outputs a 256-dimensional biological feature vector. The generative AI cooperation unit combines the video feature vector and the biological feature vector. The generative AI cooperation unit inputs the combined vector to a transformer-based cross-attention mechanism. The generative AI cooperation unit calculates a correlation between different modalities. The generative AI cooperation unit outputs a final abnormality probability score as a continuous value in a range of 0 to 1. The generative AI cooperation unit determines that an abnormality has occurred when the abnormality probability score exceeds a preset dynamic threshold value. The generative AI cooperation unit outputs a class label indicating a type of abnormality. The generative AI cooperation unit inputs this class label and profile information of a target person to a large language model. The generative AI cooperation unit generates a recommended response procedure text in a natural language using the large language model. The generative AI cooperation unit transfers the generated text to a subsequent notification module. The generative AI cooperation unit uses a cross-entropy error function in model learning. The generative AI cooperation unit optimizes a network weight by a gradient descent method. The generative AI cooperation unit realizes detection of a minute abnormality impossible by human visual monitoring by these processes. The generative AI cooperation unit dramatically improves safety and efficiency of facility operation.

Specific examples of a prompt sentence to be read by the generative AI when implementing the present invention include “Determine walking, a fall, a sitting position, a standing position, an eating action, an excretion action, a sleeping posture, wandering, a non-action state, a rehabilitation exercise, a fall sign action, an abnormal stagger, a rapid posture change, leaving a bed, a wheelchair use status, a cane or walker use status, contact with another person, an action stop after a fall, and the like with high accuracy from camera video in a nursing home facility, and detect an abnormal action”, “Analyze time-series data such as a heart rate, a body temperature, a blood pressure, a blood oxygen concentration, a respiration rate, acceleration, a walking speed, a stride, a posture, a skin potential, a sweating amount, position information, and environmental information acquired from a wearable terminal, automatically learn a baseline for each individual, and detect an abnormality pattern and a health risk with high accuracy”, “Integrally analyze camera video and biological information, detect an abnormality such as a fall, a heart rate abnormality, a body temperature abnormality, wandering, non-action, respiratory arrest, a seizure, and a fall sign in real time, automatically determine severity, and automatically generate optimal notification details and a recommended response procedure”, “Predict a future risk from a past abnormality occurrence tendency and a life pattern, and automatically generate an advance warning and advice to a staff”, and “Analyze life data such as a meal intake, a rehabilitation implementation status, and a medication compliance rate, and generate individually optimized advice for health maintenance and risk reduction”. Specifically, the system structures these prompt sentences into a format interpretable by a large language model. The system divides the prompt sentence into a system prompt and a user prompt. The system describes a constraint condition based on medical and nursing care expertise in the system prompt. The system embeds real-time sensor data and metadata of a video analysis result in a JSON format in the user prompt. The system divides an input text into a token sequence in units of subwords by a tokenizer. The system converts each token into a high-dimensional embedding vector. The system adds positional encoding to the embedding vector. The system inputs it to an encoder layer of a transformer. The system allocates a weight to an important element in input data by a self-attention mechanism. The system finds a strong relevance between two pieces of information, for example, a heart rate of 120 and a fall detection flag being true. The system predicts a next token through a decoder layer. The system generates a text autoregressively. The system generates structured text data such as high urgency level and recommended response: immediately visit a room and check consciousness as an output. The system verifies whether a format of an output text is correct using a regular expression. The system passes the text that has passed the verification to a subsequent display processing unit. The system enables a complex situation judgment that cannot be handled by a simple rule-based conditional branch by these processes. The system presents a specific and executable action to a staff.

### Implementation Steps

Step 1: Acquisition and Transmission of Camera Video Cameras such as a fixed type, a movable type, a wide-angle type, an infrared type, and a night vision type installed in various places such as a private room, a corridor, a dining room, a toilet, a bathroom, a living room, a lounge, a rehabilitation space, an entrance, and a vicinity of an emergency exit in a facility acquire clear video data day and night, and transmit the video data to a server in real time via a network. For example, at night, an infrared camera or a night vision camera is used to accurately capture a movement of a resident even in a state where lighting is turned off, and in a place requiring privacy consideration such as a bathroom or a toilet, face recognition or a mosaic process is executed in real time to extract only minimum necessary information. Specifically, the camera information acquisition unit executes advanced edge computing in each camera device. The camera information acquisition unit acquires an uncompressed RGB image tensor from an image sensor at a rate of 30 frames per second. The camera information acquisition unit sets a resolution of the image tensor to 1920 by 1080 pixels. The camera information acquisition unit applies a histogram equalization process to the acquired image tensor. The camera information acquisition unit enhances contrast in a low-illuminance environment. The camera information acquisition unit activates a lightweight object detection neural network on an edge device. The camera information acquisition unit extracts bounding box coordinates of a person in an image. The camera information acquisition unit thins out pixel data of a background region. The camera information acquisition unit holds only a region of interest where a person exists at a high resolution. The camera information acquisition unit significantly reduces a data amount to be transmitted by this process. The camera information acquisition unit encodes a processed image frame using an H.265 video compression standard. The camera information acquisition unit encapsulates an encoded bitstream with an RTSP protocol. The camera information acquisition unit starts streaming transmission toward a cloud server. The camera information acquisition unit monitors a network delay and jitter. The camera information acquisition unit automatically requests retransmission of a key frame when detecting a packet loss. The camera information acquisition unit minimizes a calculation load on a cloud side and consumption of a communication bandwidth by these processes. The camera information acquisition unit constructs a real-time and stable video monitoring infrastructure.
Step 2: Acquisition and Transmission of Biological Information by Wearable Terminal A wearable terminal such as a wristband type, a pendant type, a clothing-integrated type, a skin-attached type, a shoe-built-in type, and an ear-hook type worn by each resident acquires various biological information such as a heart rate, a body temperature, a blood pressure, a blood oxygen concentration, a respiration rate, acceleration, a gyro, a skin potential, a sweating amount, position information, and environmental information at regular intervals, and transmits data to a gateway terminal in a facility or directly to a server using various wireless communication methods such as Bluetooth, Wi-Fi, LPWA, ZigBee, and LTE. For example, a wristband-type terminal constantly measures a heart rate, a body temperature, acceleration, and a blood oxygen concentration, a pendant-type terminal detects an impact at a time of a fall and measures a respiration rate, and a clothing-integrated terminal acquires a change in a body surface temperature and a posture with high accuracy. Specifically, the biological information acquisition unit synchronously controls a plurality of sensors using a microcontroller in a wearable terminal. The biological information acquisition unit acquires a photoplethysmogram signal from an optical heart rate sensor at a sampling frequency of 100 hertz. The biological information acquisition unit acquires an acceleration vector including a gravitational acceleration component from a 3-axis acceleration sensor at a sampling frequency of 50 hertz. The biological information acquisition unit converts an acquired analog signal into digital data by an analog-to-digital converter. The biological information acquisition unit applies a digital low-pass filter to the digital data. The biological information acquisition unit removes high-frequency noise and power supply noise accompanying a body movement. The biological information acquisition unit calculates a heartbeat interval from data after noise removal using a peak detection algorithm. The biological information acquisition unit calculates a moving average from acceleration data and estimates a posture angle. The biological information acquisition unit packs these processed data into a JSON format payload together with a time stamp. The biological information acquisition unit transmits the payload to a nearby gateway using a Bluetooth Low Energy protocol. The biological information acquisition unit receives data from a plurality of terminals at the gateway. The biological information acquisition unit reconstructs the data into a time-series multidimensional array. The biological information acquisition unit publishes reconstructed array data to a message broker of a cloud server using an MQTT protocol. The biological information acquisition unit monitors a remaining battery level of a terminal. The biological information acquisition unit shifts to a power saving mode in which a sampling rate is dynamically lowered when a battery is low. The biological information acquisition unit achieves both long-term continuous operation and highly accurate data collection by these processes. The biological information acquisition unit realizes comprehensive health monitoring while reducing a burden on a resident.
Step 3: Video Data Analysis and Action Determination by Generative AI A generative AI receives camera video data on a server, combines various algorithms such as skeleton estimation, action classification, object detection, face recognition, posture estimation, gesture recognition, and facial expression analysis, and determines various actions and states such as walking, a fall, a sitting position, a standing position, an eating action, an excretion action, a sleeping posture, wandering, a non-action state, a rehabilitation exercise, a fall sign action, an abnormal stagger, a rapid posture change, leaving a bed, a wheelchair use status, a cane or walker use status, contact with another person, and an action stop after a fall with high accuracy. For example, in a case of a fall, a rapid posture change, contact with a floor, a state of not moving for a certain period of time, contact with a surrounding object, a staggering action before a fall, and the like are compositely analyzed to distinguish from normal sitting or lying down. As a specific example of a prompt sentence to be read by the generative AI, “Determine walking, a fall, a sitting position, a standing position, an eating action, an excretion action, a sleeping posture, wandering, a non-action state, a rehabilitation exercise, a fall sign action, an abnormal stagger, a rapid posture change, leaving a bed, a wheelchair use status, a cane or walker use status, contact with another person, an action stop after a fall, and the like with high accuracy from camera video in a nursing home facility, and detect an abnormal action” is given. Specifically, the server decodes a received video stream and generates a tensor of continuous image frames. The server inputs an image tensor to a deep learning-based skeleton estimation model. The server outputs a two-dimensional coordinate vector of a main joint such as a head, a shoulder, an elbow, and a knee of a person. The server calculates a displacement of joint coordinates between a plurality of continuous frames. The server derives a velocity vector and an acceleration vector of each joint. The server inputs these kinematic feature amounts to a graph convolutional network. The server simultaneously learns a spatial connection and a temporal change between joints. The server applies a softmax function in a final layer of a network. The server outputs a probability distribution corresponding to each action class such as walking and a fall. The server outputs a score that a probability of a fall class is 0.85, for example. The server determines an action label when an output probability score exceeds a prescribed threshold value. The server re-evaluates a physical feature such as a rapid drop in a height coordinate of a joint and a reduction in a distance to a floor surface when determined as a fall. The server filters a false detection. The server records a determined action label and a time stamp in a database. The server transmits an action label to a subsequent integrated analysis module. The server realizes objective and continuous action monitoring independent of human visual observation by these processes. The server instantaneously detects occurrence of a serious accident such as a fall and prevents a delay in response.
Step 4: Biological information data analysis and abnormality detection by generative AI. On a server, a generative AI analyzes time-series data such as a heart rate, a body temperature, a blood pressure, a blood oxygen concentration, a respiration rate, an acceleration, a walking speed, a stride length, a posture, a skin potential, a sweating amount, position information, and environmental information transmitted from a wearable terminal, automatically learns a baseline for each individual, and detects an abnormality pattern and a health risk with high accuracy. For example, an abnormality sign is detected by combining a plurality of biological indicators such as an abnormal rise or drop in the heart rate, a rapid body temperature change, a blood oxygen concentration drop, long-time inactivity, frequent waking up at night, an abnormal respiration rate, an impact waveform at a time of a fall, a decrease in the walking speed, a change in the stride length, a posture collapse, a change in the skin potential, an increase in the sweating amount, and a correlation with an environmental factor. As a specific example of a prompt sentence to be read by the generative AI, “Analyze time-series data such as a heart rate, a body temperature, a blood pressure, a blood oxygen concentration, a respiration rate, an acceleration, a walking speed, a stride length, a posture, a skin potential, a sweating amount, position information, and environmental information acquired from a wearable terminal, automatically learn a baseline for each individual, and detect an abnormality pattern and a health risk with high accuracy” can be cited. Specifically, the server normalizes the received multidimensional time-series data. The server unifies a scale of each biological indicator. The server inputs the normalized time-series array into an autoencoder-type neural network. The server compresses the data into a low-dimensional latent space vector in an encoder unit. The server reconstructs the original time-series data from the latent space vector in a decoder unit. The server pre-trains this network using only normal data. The server calculates a mean square error between the input data and the reconstructed data. The server defines the calculated reconstruction error as an abnormality score. The server determines an abnormality when the abnormality score for unknown input data exceeds a statistically set threshold value. The server extracts data of the past few weeks for each individual by a sliding window method. The server dynamically updates an average value and a standard deviation that serve as the baseline of the individual. The server calculates a Mahalanobis distance between a current measurement value and the baseline. The server executes outlier detection considering a correlation among multiple variables. The server detects, for example, a state in which the heart rate is higher than usual and the acceleration is zero as an abnormality during sleeping. The server generates metadata indicating a type of abnormality and a severity level of the detected abnormality. The server transfers this metadata to a subsequent integrated analysis module. The server captures a minute physical condition change peculiar to an individual that cannot be detected by a fixed threshold value through these processes. The server enables early discovery of a disease and a preventive intervention.
Step 5: Multivariate integrated analysis and abnormality notification determination by generative AI. On the server, the generative AI integrates a camera video analysis result and a biological information analysis result, detects an abnormality such as a fall, a heart rate abnormality, a body temperature abnormality, wandering, inactivity, respiratory arrest, a seizure, and a fall sign in real time, automatically determines a severity level, and automatically generates optimal notification details and a recommended response procedure. For example, in fall detection, a highly accurate fall determination is performed by combining motion analysis of a camera video and acceleration data of the wearable terminal, and a severity level determination when a plurality of abnormalities occur simultaneously, and at a time of an abnormality occurrence, a latest action history, a vital transition graph, a video clip, a comparison result with a past similar case, a recommended response procedure, and the like are also automatically generated and included in the notification details. As a specific example of a prompt sentence to be read by the generative AI, “Integrate and analyze a camera video and biological information, detect an abnormality such as a fall, a heart rate abnormality, a body temperature abnormality, wandering, inactivity, respiratory arrest, a seizure, and a fall sign in real time, automatically determine a severity level, and automatically generate optimal notification details and a recommended response procedure” can be cited. Specifically, the server acquires a probability vector of an action label output from a video analysis module and an abnormality score vector output from a biological information analysis module. The server synchronizes these vectors on a time axis. The server combines the synchronized vectors to generate an integrated feature vector. The server inputs the integrated feature vector into a multilayer perceptron. The server passes it through an attention layer that dynamically adjusts weighting of each modality. The server non-linearly amplifies a certainty factor of a fall when a rapid posture change in the video and a large impact acceleration in the biological data occur simultaneously. The server outputs a comprehensive severity score in a range of 0 to 100 from a final layer. The server determines an emergency when the comprehensive severity score is 80 or more. The server calls an inference API of a large language model using a determination result as a trigger. The server passes a current vital numerical value, an action label, and past medical history data in a JSON format as an input prompt. The server causes the large language model to output a specific text saying that the subject has fallen and the heart rate is rising rapidly, please check consciousness immediately and request an ambulance if necessary. The server packages the generated text and a URL of the video clip at a corresponding time. The server registers the packaged data in a notification queue. The server dramatically reduces a false alarm that is likely to occur with a single sensor through these processes. The server provides an accurate action guideline in line with a context of a situation to a staff.
Step 6: Abnormality notification and information linkage to a related person. When an abnormality is detected, the server immediately notifies a terminal (a smartphone, a tablet, a personal computer, a wearable display, etc.) of a care staff or a medical staff of abnormality details by various methods such as a push notification, an alert sound, a vibration, an email, an automatic call by voice synthesis, and an interactive notification by a chatbot. The notification details include a name of the resident, a type of abnormality, an occurrence place, an occurrence time, latest vital data, a video thumbnail and an analysis result, a recommended response procedure, an urgency level, a past similar case, contact information to a medical institution, a contact status to a family member, and the like. Furthermore, in a case of a serious abnormality, necessary information is also notified to a family member of a registered emergency contact by SMS, an email, an automatic voice call, a dedicated application notification, a chatbot notification, or the like. Specifically, the abnormality detection and notification unit acquires packaged alert data from the notification queue. The abnormality detection and notification unit analyzes the urgency level included in the alert data. The abnormality detection and notification unit dynamically determines a routing destination of the notification according to the urgency level. The abnormality detection and notification unit issues a query to a shift management database of the staff. The abnormality detection and notification unit acquires a terminal ID list of staffs who are currently on duty and in charge of a target residential area. The abnormality detection and notification unit calls an external API of a standard push notification service or a cloud messaging service provided by a mobile OS. The abnormality detection and notification unit transmits a payload in a JSON format to a target terminal. The abnormality detection and notification unit includes a designation of a vibration pattern and a custom alert sound in the payload. The abnormality detection and notification unit forcibly turns on a screen and pops up a notification dialog on a terminal side. The abnormality detection and notification unit monitors a pressing event of a response confirmation button from the staff. The abnormality detection and notification unit activates an escalation process when there is no response within a certain period of time. The abnormality detection and notification unit automatically transmits a secondary notification to a terminal of a facility manager or an affiliated medical institution. The abnormality detection and notification unit activates a text-to-speech engine. The abnormality detection and notification unit converts an alert text into synthesized voice data. The abnormality detection and notification unit cooperates with a PBX system using a SIP protocol. The abnormality detection and notification unit automatically makes a call to a PHS of the staff or a telephone number of the family member. The abnormality detection and notification unit completely prevents an information transmission omission through these processes. The abnormality detection and notification unit minimizes a delay in an initial response in an emergency and contributes to an improvement in a lifesaving rate.
Step 7: Information visualization and business support by a management screen. The management screen display unit on the server enables a facility staff to display a list of a current activity status of all residents, latest vital data, a past abnormality occurrence history, a response status, a notification history, a staff response history, a family contact history, a rehabilitation implementation status, a meal intake status, a medication status, a life pattern analysis, an abnormality tendency analysis, a risk prediction by AI, a recommended response advice, and the like in real time from a terminal (a personal computer, a tablet, a smartphone, etc.), and efficiently manage daily health management and a response history at a time of an abnormality occurrence. Specifically, the management screen display unit is implemented as a single-page application operating on a web browser. The management screen display unit establishes WebSocket communication with the server. The management screen display unit asynchronously receives latest sensor data and an AI analysis result push-distributed from the server. The management screen display unit parses the received JSON data. The management screen display unit updates a store of a front-end state management library. The management screen display unit executes a difference calculation algorithm of a virtual DOM. The management screen display unit re-renders only a component requiring a change on a screen at high speed. The management screen display unit draws a vital transition of the resident as a time-series line graph. The management screen display unit uses a Canvas API or SVG for drawing the graph. The management screen display unit changes a graph background color of a time zone in which an abnormality is detected to red. The management screen display unit performs a visual alert. The management screen display unit maps a current position of each resident as an icon on a floor map. The management screen display unit overlays and displays a text of a current heart rate and an action state in a vicinity of the icon. The management screen display unit displays a detailed profile and a past response history in a modal window when the staff clicks the icon. The management screen display unit transmits a search query to a database via a RESTful API. The management screen display unit displays history data matching a specific period or condition in a table format with pagination. The management screen display unit provides an interface capable of intuitively grasping a huge amount of data through these processes. The management screen display unit reduces a cognitive load on the staff and significantly improves business efficiency.
Step 8: Data accumulation, long-term storage, and reuse. The data accumulation unit on the server securely stores all video data, vital data, abnormality detection histories, notification histories, staff response histories, family contact histories, rehabilitation histories, meal histories, medication histories, life pattern analysis results, AI analysis results, and the like for a long period of time, and can utilize them for re-verification of a past fall case, an inquiry from a family member, a report to an administration, an abnormality tendency analysis by AI, generation of a risk prediction report, and the like. Specifically, the data accumulation unit adopts a distributed database architecture excellent in scalability. The data accumulation unit uses a dedicated time-series database to process time-series vital data occurring at a high frequency. The data accumulation unit adds a time stamp and tag information to each data point and stores it in a columnar format. The data accumulation unit maximizes a data write throughput. The data accumulation unit stores large-capacity video data in an object storage. The data accumulation unit stores metadata and a URL link of a video file in a relational database. The data accumulation unit applies a sharding technology to distribute a load on the database. The data accumulation unit divides and arranges data in a plurality of physical nodes using an ID of the resident as a hash key. The data accumulation unit constantly executes a replication process to ensure data availability. The data accumulation unit synchronizes data of a main node to a plurality of standby nodes. The data accumulation unit applies a data lifecycle management policy. The data accumulation unit holds data of the latest one month with a high access frequency in a high-speed solid state drive. The data accumulation unit automatically archives older data before that to an inexpensive hard disk drive or a cold storage. The data accumulation unit applies a batch processing framework to the accumulated big data. The data accumulation unit automatically generates a monthly or annual statistical report. The data accumulation unit supplies data to a relearning pipeline of a machine learning model. The data accumulation unit prevents data siloing through these processes. The data accumulation unit strongly supports data-driven facility operation and continuous accuracy improvement of an AI model.

### Specific Use Case

For example, in an elderly facility such as a nursing home, a situation is assumed in which a resident leaves a bed in his/her own room at night and falls on the way to a toilet. In this case, the camera information acquisition unit acquires an action of the resident as video data in real time using an infrared camera or a night vision camera installed in a corridor or near the toilet, and transmits it to the server. The biological information acquisition unit acquires a heart rate, a body temperature, an acceleration, a blood oxygen concentration, position information, and the like at regular intervals from a wristband-type wearable terminal worn by the resident, and similarly transmits them to the server. A generative AI linkage unit performs skeleton estimation and motion classification from a camera video, compositely analyzes a rapid posture change from a walking motion, contact with a floor, a state of not moving for a certain period of time, and the like, and determines a fall motion with high accuracy. Furthermore, acceleration data and a sudden change in the heart rate from the wearable terminal are also analyzed simultaneously to increase an accuracy of the fall. When a fall is detected, the abnormality detection and notification unit immediately transmits a detailed notification including a name of the resident, a fall occurrence place, an occurrence time, a camera video thumbnail immediately before and after the fall, a transition graph of the heart rate and the body temperature, a recommended response procedure, and the like to a terminal for a staff. When it is determined to be a serious abnormality, a fact of the fall occurrence, a current response status, contact information to the facility, and the like are automatically notified also to a terminal of a registered family member. The management screen display unit visualizes a fall occurrence history, a past fall tendency, a night activity pattern, a vital data transition before and after the fall, a staff response history, and the like of the resident in a graph or a list, and can utilize them for future risk management, explanation to a family member, an administrative report, and the like. The data accumulation unit stores all data of the fall case for a long period of time, and uses it for later re-verification, an abnormality tendency analysis by AI, and generation of a risk prediction report. Specifically, the system executes a plurality of algorithms in a chained manner in this series of processes. The system streams a grayscale image tensor acquired from the infrared camera to the server. The system inputs the image tensor into a high-speed object detection model that performs processing in a single pass on a server side. The system extracts a bounding box of a person in the dark. The system inputs the extracted region into a skeleton estimation model and acquires a time-series change of joint coordinates as a vector. The system detects that a Y coordinate of a head has dropped by 1 meter or more within 0.5 seconds. The system simultaneously analyzes 3-axis acceleration data transmitted from the wearable terminal. The system confirms that a composite acceleration vector has recorded a spike waveform exceeding 3G. The system detects that heart rate data has rapidly risen from 70 in a normal state to 120. The system inputs these feature vectors into a support vector machine. The system outputs 0.98 as a probability score of a fall class. The system confirms a fall event because this score exceeds a threshold value of 0.8. The system immediately generates an alert payload. The system includes a flag of a fall occurrence and a Base64 encoded character string of a video frame at a corresponding time in the payload. The system push-transmits the payload to a smartphone of the staff via a WebSocket. The system activates a dedicated application on the smartphone and sounds a warning sound. The system draws a text saying that resident A has fallen in the corridor, there is a heart rate abnormality, please check immediately, and a video thumbnail on an application screen. The system receives an event in which the staff taps a response start button on the application. The system records a response start time in the database. The system immediately detects an accident occurring in a blind spot at night through these processes. The system supports a prompt rush of the staff and prevents a serious health damage.

For example, a situation is assumed in which the number of chews and swallowing motions of a resident significantly decrease during a meal in a dining room, and a meal intake amount decreases. In this case, the camera information acquisition unit acquires a meal motion from a wide-angle camera installed in the dining room, and the generative AI linkage unit analyzes a hand movement, a motion to a mouth, a usage status of tableware, the number of chews, a swallowing motion, and the like. The biological information acquisition unit acquires a heart rate, a body temperature, an acceleration, a sweating amount, and the like from the wearable terminal, and analyzes a biological reaction during the meal. The generative AI compares them with a tendency of a past meal intake amount, the number of chews, and a swallowing motion, and when detecting an abnormal decrease, transmits a notification such as “meal intake amount decrease”, “number of chews decrease”, and “swallowing motion decrease” to a staff terminal to prompt an early response. The management screen display unit displays a transition graph of the meal intake amount, an abnormality detection history, and a staff response history, and contributes to nutrition management and early discovery of a dysphagia risk. Specifically, the system activates a dedicated image processing pipeline for quantifying a minute motion during a meal. The system crops a face region of the resident from a video of the wide-angle camera using a face detection algorithm. The system applies an optical flow analysis to the cropped face image. The system calculates a displacement vector of a pixel indicating an up-and-down movement of a jaw and a movement of a cheek muscle. The system converts a periodic fluctuation of the displacement vector into frequency domain data by Fourier transform. The system digitizes the number of chews per minute by counting peaks in a specific frequency band. The system tracks a movement of an Adam's apple. The system counts the number of swallowing motions. The system analyzes acceleration data and gyro data of the wearable terminal worn on a wrist. The system reconstructs a trajectory of a motion of carrying a spoon or chopsticks to the mouth in a three-dimensional space. The system integrates the number of motions from a start to an end of the meal. The system compares these real-time data with average data of the past one month. The system detects that the number of chews has decreased by 30 percent or more from a baseline. The system determines that a pace of the meal has become extremely slow. The system inputs these determination results as feature amounts into a random forest classifier. The system calculates a score of a swallowing function decline risk. The system push-transmits a warning message to the terminal of the staff when the risk score is high. The system draws a scatter plot of the daily number of chews and a meal time on the management screen. The system discovers an initial sign of a feeding and swallowing disorder that is difficult to notice visually based on objective data through these processes. The system supports prevention of aspiration pneumonia and a change to an appropriate food form.

For example, a situation is assumed in which a resident leaves a bed at night, does not return for a long time, and wanders in the facility. In this case, the camera information acquisition unit acquires a movement route and an action pattern of the resident from a camera video of a corridor or a common space, and the generative AI linkage unit detects an abnormal wandering action by collating them with time information and a past life pattern. The biological information acquisition unit acquires position information and acceleration data from the wearable terminal, and analyzes a wandering range, a moving speed, and a change in a walking pattern. The abnormality detection and notification unit transmits a notification such as “night wandering”, “long-time bed leaving”, and “abnormal movement route” to a staff terminal to prompt a prompt response. The management screen display unit displays a wandering occurrence history, a movement route map, and a transition graph of a night activity pattern, and can utilize them for future risk management and explanation to a family member. Specifically, the system executes advanced flow line monitoring by combining an indoor positioning technology and a trajectory analysis algorithm. The system acquires a radio wave intensity indicator received by the wearable terminal from a plurality of Bluetooth beacons arranged in the facility. The system applies a trilateration algorithm and a Kalman filter. The system estimates XY coordinates of the resident at 1-second intervals while removing noise. The system holds time-series data of the estimated coordinates as a trajectory vector in a memory. The system integrates a movement vector of a person extracted from the camera video and the trajectory vector of the indoor positioning. The system improves an accuracy of the position information. The system applies a density-based clustering algorithm such as DBSCAN to the trajectory vector. The system determines whether the resident is staying in a specific area or continues to move aimlessly. The system interlocks with data of a load sensor installed in the bed. The system detects that a bed leaving state has exceeded 30 minutes which is a set threshold value. The system compares a past normal toilet movement trajectory pattern and a current trajectory pattern using a dynamic time warping algorithm. The system determines that it is an abnormal wandering route when a similarity score between the two is remarkably low. The system sets a wandering flag to true. The system transmits a JSON payload including coordinate data of a current position and polygon data of a movement route to the staff terminal. The system renders a wandering trajectory in red on a heat map of the management screen. The system accurately identifies an irregular action pattern peculiar to a dementia patient through these processes. The system prevents an accident of leaving the facility and significantly reduces a search burden on the staff.

For example, when a resident performs a rehabilitation exercise in a rehabilitation space, the camera information acquisition unit acquires an exercise form, the number of motions, and an exercise time, and the generative AI linkage unit evaluates whether the exercise is performed in a correct form in real time. The biological information acquisition unit acquires a heart rate, an acceleration, and posture data from the wearable terminal, and analyzes a biological reaction and an exercise intensity during rehabilitation. The generative AI compares them with a past rehabilitation implementation status and an exercise pattern, and when detecting a lack of exercise, a poor form, and a decline in a rehabilitation effect, transmits a notification such as “lack of rehabilitation implementation”, “poor form”, and “exercise intensity decline” to a staff terminal to prompt a review of a rehabilitation plan and individual guidance. The management screen display unit displays a rehabilitation implementation history, an exercise form evaluation, and an exercise intensity transition graph, and can utilize them for visualization of a rehabilitation effect and information sharing among staffs. Specifically, the system executes a biomechanics analysis using computer vision. The system extracts three-dimensional joint coordinates of the resident at 30 frames per second from a camera video using a skeleton estimation model. The system calculates a flexion angle and an extension angle of a shoulder joint, a hip joint, and a knee joint from the extracted joint coordinates by an inner product calculation. The system generates time-series data of the calculated angles as an exercise kinematics vector. The system reads a reference vector of an ideal exercise form registered in advance by a physical therapist from a database. The system calculates a Euclidean distance between the exercise kinematics vector of the resident and the reference vector. The system outputs a reciprocal of the distance as a form accuracy score in a range of 0 to 100. The system calculates an exercise intensity based on a Karvonen method using heart rate data acquired from the wearable terminal. The system determines whether a target heart rate zone has been reached. The system activates a feedback process when the form accuracy score falls below 70 or when the exercise intensity does not reach a target value. The system draws a text saying please bend your knees more and an annotation image emphasizing a joint part to be corrected in real time on a display installed in the rehabilitation space. The system aggregates the number of exercises, an average form score, and consumed calories after an end of a series of rehabilitation sessions. The system stores the aggregated data in a database in a structured JSON format. The system renders a trend graph indicating a daily form improvement degree on the management screen. The system provides high-quality rehabilitation even if a professional is not permanently stationed through these processes. The system quantitatively evaluates an effect of exercise therapy and supports creation of an individualized care plan.

For example, in medication management, a case where a resident forgets to take medication is assumed. The biological information acquisition unit records a medication time and detects a medication action from the wearable terminal, and a generative AI cooperation unit analyzes a medication compliance rate and a tendency to forget medication. When forgetting to take medication is detected, a notification such as “forgot to take medication” or “medication compliance rate drop” is transmitted to a staff terminal or a family terminal to prompt a medication reminder or medication support. The management screen display unit displays a medication history, a compliance rate transition, and a history of forgetting to take medication, which can be utilized for thorough medication management and explanation to a family member. Specifically, the present system tracks a micro state transition of a medication behavior using sensor fusion technology. The present system receives an interrupt signal of a state change from an opening/closing sensor installed in a medicine box. The present system acquires data on rotation and inclination of a wrist from a 3-axis acceleration sensor and a gyro sensor of the wearable terminal. The present system inputs the acquired sensor data into a hidden Markov model. The present system calculates probabilities of a series of sequential action phases of reaching for the medicine box, taking out the medicine, bringing the medicine to the mouth, and drinking water. The present system sets a medication completion flag to true only when each phase is executed in a correct order. The present system operates a timer process that compares a specified medication time registered in a prescription database with a current time. The present system detects a state in which the medication completion flag remains false even after 30 minutes have elapsed from the specified time. The present system generates a medication forgetting event. The present system inputs past medication history data into a logistic regression model. The present system predicts a future medication non-compliance probability from feature quantities such as a day of the week, a time zone, and an immediately preceding activity state. The present system transmits a push notification to the terminal of the staff when the medication forgetting event occurs. The present system includes a message “Medication of resident B after lunch cannot be confirmed. Please check.” in a notification payload. The present system draws a monthly medication compliance rate in a pie chart on a management screen. The present system displays an average time of medication delay in a bar chart. The present system realizes reliable medication management that does not depend on human memory or self-reporting by these processes. The present system physically and logically prevents health damage caused by forgetting to take medicine or taking an overdose.

Specific examples of a prompt sentence to be read by the generative AI include “Integrate various data acquired from camera video and wearable terminals, detect abnormalities and risks such as a fall, a heart rate abnormality, a body temperature abnormality, wandering, inactivity, a food intake drop, a chewing count decrease, a swallowing action decrease, insufficient rehabilitation implementation, poor form, and forgetting to take medication with high accuracy, automatically determine a severity level, and automatically generate optimal notification details and a recommended response procedure” and “Analyze past abnormality occurrence tendencies, life patterns, rehabilitation histories, meal histories, medication histories, and the like, predict future health risks and daily life issues, and automatically generate advance warnings and individually optimized advice for staff and family members”. Specifically, the present system incorporates these prompts into a retrieval-augmented generation architecture and executes them. Prior to inputting the prompt, the present system stores text data of past incident reports and medical guidelines in the facility in a vector database. When a user prompt is input, the present system converts the text into a high-dimensional vector using an embedding model. The present system executes a cosine similarity search on the vector database. The present system extracts the top three past cases and medical grounds most relevant to the current situation. The present system combines the extracted context information with the original prompt. The present system transmits the augmented prompt to an API endpoint of a large language model. The present system sets a temperature, which is an inference parameter of the large language model, to 0.2. The present system suppresses hallucination and forces a fact-based deterministic output. The present system acquires a specific inference result in a JSON format from the large language model, such as “In past similar cases, there have been reports of cases where a rapid blood pressure drop after a meal caused a fall. Since the current vital data matches this pattern, please have the resident maintain a seated position immediately and remeasure vital signs.” The present system parses the acquired JSON data. The present system extracts an action item and automatically registers it in a task management database. The present system specializes a general-purpose AI model to a specific medical and nursing care domain by these processes. The present system provides advanced decision-making support equivalent to that of a skilled medical worker even to inexperienced staff. (Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

Embodiments of the present invention will be described in detail more specifically and comprehensively.

The system of the present invention is an autonomous factory robot safety and efficiency management system that collects robot operation video, overall work site video, machine state data, and surrounding environment data in real time from a wide variety of cameras installed in all sites such as an automated line, an assembly cell, a transport system, a picking area, a welding process, a painting process, an inspection process, a palletizing area, an AGV travel path, a worker coexistence area, and a maintenance and inspection space in a factory, and various sensor terminals mounted on a robot main body and peripheral equipment, integrally and multilaterally analyzes these multidimensional data using generative AI to automatically detect complex abnormal operations, minute failure signs, a work efficiency drop, a dangerous behavior, a process deviation, a human contact risk, a maintenance necessity, and the like, which have been difficult to detect by conventional threshold determination or simple alerts, with high accuracy, and realizes immediate notification to an administrator or a maintenance person, visualization of an overall situation on a management screen, recording of a response history at a time of an abnormality occurrence, long-term storage of all data, and utilization for AI model relearning. Specifically, the present system adopts a distributed processing architecture that dynamically allocates computing resources distributed between an edge device and a cloud server. The present system implements each functional unit as a containerized microservice. The present system constructs a multimodal neural network integrating an image processing unit and a time-series data processing unit. The neural network receives an image tensor and a numerical vector as an input layer. The image tensor is, for example, a three-dimensional array obtained by normalizing RGB image data of 3 channels with a resolution of 1920×1080 pixels. The numerical vector is, for example, a four-dimensional array combining 3-axis data from an acceleration sensor and one-dimensional data from a temperature sensor. The neural network extracts feature quantities using a convolutional layer and a self-attention mechanism. The neural network combines the extracted feature quantities in a high-dimensional space. The neural network outputs an abnormality probability score and an abnormality classification label from an output layer. The abnormality probability score is a continuous value from 0.0 to 1.0. The abnormality classification label is, for example, a one-hot vector indicating a category such as “normal”, “bearing wear sign”, or “arm trajectory deviation”. The present system activates a subsequent notification processing module when the output abnormality probability score exceeds a preset threshold value. The present system generates structured data including an abnormality occurrence location and a recommended response procedure in the notification processing module. The present system transmits the generated structured data to a terminal of the administrator. The present system executes such an unconventional calculation in a high-dimensional space. The present system realizes early discovery of a minute abnormality that is impossible by human visual inspection or simple rule-based threshold determination. The present system brings about technical effects of improving an operation rate of the entire factory and reducing maintenance costs. The present system is applicable to a large-scale production line such as an automobile manufacturing factory or a semiconductor manufacturing factory.

The camera information acquisition unit constantly captures, for example, an operation of a robot arm in an assembly cell, a workpiece gripping/releasing operation of an end effector, a picking/palletizing operation of a collaborative robot on a transport line, a trajectory of a torch and weld bead formation in a welding process, a movement of a spray gun in a painting process, a visual inspection operation and a defective product discharge operation in an inspection process, a travel path and an obstacle avoidance operation of an AGV, a cooperative operation with a worker, and a contact risk between a person and a robot during maintenance work, at multiple angles, high resolution, and a high frame rate by combining a fixed type, a movable type, a wide-angle type, an infrared type, a night vision type, a high-speed shooting type, a camera with a zoom function, and the like, and transmits video data to the server. For example, at night or in a dark place, an infrared camera or a night vision camera is used to accurately capture movements of the robot and the workpiece even in an environment with insufficient lighting. For example, using a movable camera or a camera with a zoom function, it is also possible to automatically switch a gaze point when a specific abnormality occurs and acquire detailed video. For example, when a worker enters a work area of the robot, the camera automatically tracks the area and records a human contact risk as video. Specifically, the camera information acquisition unit operates in cooperation with an edge computing device. The camera information acquisition unit executes preprocessing on acquired raw video data in real time. The camera information acquisition unit performs noise removal and resolution conversion as the preprocessing. The camera information acquisition unit converts the preprocessed video data into a time-series image tensor. The image tensor is, for example, a four-dimensional array of 30 frames, 224 pixels vertically, 224 pixels horizontally, and 3 channels. The camera information acquisition unit inputs this image tensor into a lightweight convolutional neural network on an edge side. The neural network outputs bounding box coordinates of a moving object region from the input image tensor. The bounding box coordinates are, for example, a four-dimensional vector indicating XY coordinates of an upper left and a lower right. The camera information acquisition unit controls a pan and tilt mechanism of the movable camera based on the output coordinate information. The camera information acquisition unit automatically tracks a specific abnormality occurrence location by this control. The camera information acquisition unit transmits a high-resolution image tensor obtained by tracking to a cloud server. The camera information acquisition unit provides this image tensor as input data to a large language model and a vision-language model on the cloud server. The camera information acquisition unit executes such unconventional image analysis and dynamic control on the edge side. The camera information acquisition unit selectively collects only important video data while suppressing consumption of a network bandwidth. The camera information acquisition unit brings about technical effects of reducing a communication load of the entire system and improving analysis accuracy by this process. The camera information acquisition unit is applicable to monitoring in a harsh environment where a field of view is easily obstructed, such as a welding process or a painting process.

The sensor information acquisition unit detects minute vibrations and impacts of a robot arm, an end effector, a transport device, and an AGV using, for example, an acceleration sensor, and extracts signs of bearing wear, gear loss, poor balance, external impact, and the like. For example, a temperature sensor monitors a temperature rise of a motor, a speed reducer, a control panel, a welding torch, a painting nozzle, and the like, and detects a cooling failure, a burnout risk, and a performance drop due to overheating at an early stage. For example, a current sensor detects abnormal fluctuations in a drive current of each axis, an inrush current, a welding current, a painting pump current, and the like, and identifies an overload, a short circuit, a control abnormality, and deterioration of consumable parts. For example, a torque sensor monitors a load fluctuation and an excessive torque of an arm, a gripper, and a transport device, and extracts a workpiece gripping mistake, mechanical interference, foreign matter biting, and overloading. For example, an encoder detects a position shift, backlash, a repeatability drop, and a travel trajectory deviation of an AGV, and grasps a control system abnormality, mechanical deterioration, and guide wear. For example, a proximity sensor or a pressure sensor monitors a gripping state of a workpiece, a collision risk, a contact risk with a worker or other equipment, load collapse during palletizing, and a workpiece drop during picking in real time. For example, a force sensor measures a pressing force of a welding torch or a painting nozzle, a gripping force of a gripper, and a contact pressure of an inspection probe, and determines whether an appropriate work is being performed. For example, an environment sensor acquires fluctuations in temperature, humidity, noise, illuminance, dust concentration, and the like, and analyzes an influence on robot operation and an abnormality occurrence factor. Specifically, the sensor information acquisition unit converts analog signals output from a plurality of sensors into digital signals. The sensor information acquisition unit inputs the converted digital signals to a synchronization processing module. The synchronization processing module aligns sensor data having different sampling rates with a common time stamp. The synchronization processing module configures the aligned data as a multidimensional time-series array. The time-series array is, for example, a 100-dimensional numerical matrix including 1000 samples for the past 10 seconds. The sensor information acquisition unit inputs this time-series array into a recurrent neural network for abnormality detection. The recurrent neural network learns long-term dependencies of time-series data using long short-term memory units. The recurrent neural network extracts a latent feature vector from the input time-series array. The recurrent neural network inputs the extracted latent feature vector to a fully connected layer. The recurrent neural network outputs a predicted value of each sensor from the fully connected layer. The predicted value is, for example, a continuous value vector indicating an expected value of temperature or vibration in the next 1 second. The sensor information acquisition unit calculates a squared error between the output predicted value and an actual observation value. The sensor information acquisition unit passes this squared error as an abnormality score to a subsequent determination module. The determination module generates an alert signal when the abnormality score exceeds a dynamically set threshold value. The sensor information acquisition unit executes such a time-series prediction calculation in a high-dimensional space. The sensor information acquisition unit captures a minute sign that is overlooked by simple threshold determination. The sensor information acquisition unit brings about a technical effect of preventing a sudden failure of mechanical equipment by this process. The sensor information acquisition unit is applicable to an automated line or a precise assembly cell operating at high speed.

The generative AI analysis unit extracts an operation pattern and a work procedure of the robot from a camera video, and determines, for example, an operation speed and acceleration of an arm, smoothness of a trajectory, a gripping/releasing timing of a workpiece, a trajectory deviation of a welding torch, a workpiece drop or miss during picking, a defective product detection operation in an inspection process, a disturbance of a painting pattern, a travel path deviation of an AGV, an inappropriate operation of a worker, and the like with high accuracy. For example, it automatically extracts an operation speed drop and an acceleration abnormality of an arm, a trajectory disturbance, a workpiece gripping failure, a trajectory deviation of a welding torch, a picking mistake, a defective product oversight in an inspection process, painting unevenness, an obstacle avoidance failure of an AGV, a safety rule violation of a worker, and the like. Regarding sensor data, it extracts a sign of bearing wear or gear loss from an abnormality pattern of an acceleration waveform, a motor burnout risk from a simultaneous fluctuation of a temperature rise and a current value, an overload or mechanical interference from a combination of a torque fluctuation and a position shift, a gripping mistake or a workpiece drop from an abnormal value of a pressure sensor, a contact risk with a person or other equipment from a reaction of a proximity sensor, a work defect or equipment damage risk from an abnormal value of a force sensor, a trouble risk due to operating environment deterioration or dust/temperature/humidity abnormality from an abnormal value of an environment sensor, and the like by multivariate analysis. The generative AI also learns past normal operation data, an abnormality occurrence history, an aging degradation tendency for each robot, a work pattern for each process, a fluctuation of a season and an operating environment, an equipment update history, a maintenance history, a skill difference of a worker, a type and a lot difference of a workpiece, and the like, and automatically generates an individually optimized abnormality detection algorithm. For example, it automatically optimizes an individual abnormality threshold value and a sign detection model in consideration of a different operation history and degradation tendency for each robot, a worker change, a workpiece material change, a process change, and the like even in the same process. For example, when a plurality of abnormalities occur simultaneously or when a pattern that is a sign of an abnormality occurrence is detected, it automatically determines a severity level and an urgency level, and automatically generates an optimal response procedure and notification details. For example, the AI learns a response history and an actual failure cause at a time of an abnormality occurrence, and automatically improves future abnormality detection accuracy and accuracy of a recommended response procedure. Specifically, the generative AI analysis unit implements a multimodal foundation model based on a large-scale transformer architecture. The generative AI analysis unit receives an image tensor from the camera information acquisition unit and a time-series array from the sensor information acquisition unit as input data. The image tensor is, for example, a sequence of image patches of 224×224 pixels. The time-series array is, for example, a normalized numerical vector of each sensor. The generative AI analysis unit inputs these input data to respective dedicated encoders. The generative AI analysis unit maps feature quantity vectors output from the encoders to a common latent space. The generative AI analysis unit calculates an interaction between an image feature quantity and a sensor feature quantity using a self-attention mechanism. The generative AI analysis unit learns a causal relationship between a specific operation and a specific sensor value fluctuation by this calculation. The generative AI analysis unit outputs an analysis result using a decoder. The output data is, for example, a score from 0.0 to 1.0 indicating an occurrence probability of an abnormality. The output data further includes a sequence of text tokens indicating a type of abnormality. The text token is, for example, a natural language character string “There is a sign of overheating in the motor of the third joint”. The generative AI analysis unit transfers this output data to a subsequent abnormality notification module. The generative AI analysis unit uses a cross-entropy error function and an Adam optimization algorithm in learning of the model. The generative AI analysis unit improves generalization performance using a data augmentation method of adding artificial noise to past normal data. The generative AI analysis unit executes such an unconventional multimodal integrated analysis. The generative AI analysis unit identifies a complex abnormality pattern that even a human expert does not notice. The generative AI analysis unit brings about technical effects of improving accuracy of abnormality detection and reducing false alarms by this process. The generative AI analysis unit is applicable to integrated management of a large-scale factory in which a wide variety of robots coexist.

When an abnormality, a failure sign, a work efficiency drop, a dangerous behavior, a maintenance necessity, or the like is detected by the generative AI analysis unit, the abnormality notification and management screen unit immediately transmits a detailed notification including identification information of a corresponding robot, abnormality details, an occurrence time, a recommended response procedure, a latest video clip and sensor graph, a past similar case, a severity level, an urgency level determination, and the like to a terminal (a personal computer, a tablet, a smartphone, a wearable terminal, or the like) of an administrator or a maintenance person. For example, when an operation speed drop and an acceleration abnormality of an arm are simultaneously detected, it transmits a notification such as “Operation speed drop and vibration abnormality detected in robot X of assembly cell A, bearing wear sign, inspection within 48 hours recommended”. For example, when a trajectory deviation of a torch and a temperature rise occur simultaneously in a welding process, it transmits a notification such as “Torch trajectory deviation and motor temperature rise detected in robot Y of welding cell B, cooling system inspection and torch trajectory correction recommended”. For example, when a travel path deviation of an AGV and obstacle detection occur simultaneously, it transmits a notification such as “Travel path deviation and obstacle detection in AGV Z of transport area C, path resetting and obstacle removal recommended”. On a management screen, an operation status of all robots, an abnormality occurrence history, a maintenance recommendation, a work efficiency transition, a past response history, a risk prediction by AI, an abnormality occurrence tendency by process, a maintenance history for each equipment, an abnormality occurrence tendency for each worker, a defective rate transition for each workpiece, and the like are visualized in a list and a graph, which can be utilized for improving safety and productivity at a site, an equipment maintenance plan, a process improvement proposal, worker education, and external audit response. Specifically, the abnormality notification and management screen unit receives structured data output from the generative AI analysis unit. The structured data is, for example, a JSON format dataset including an abnormality score, an abnormality category, occurrence coordinates, and a recommended response procedure. The abnormality notification and management screen unit analyzes this structured data and determines a priority of notification. The abnormality notification and management screen unit uses a decision tree algorithm for priority determination. The abnormality notification and management screen unit uses the abnormality score and an importance parameter of target equipment as inputs to the decision tree algorithm. The abnormality notification and management screen unit outputs a notification level from the decision tree algorithm. The notification level is, for example, a three-stage category value of “emergency stop”, “immediate inspection”, and “periodic maintenance”. The abnormality notification and management screen unit executes a subsequent routing process based on this notification level. In a case of “emergency stop”, the abnormality notification and management screen unit transmits a stop signal directly to an equipment control programmable logic controller. In a case of “immediate inspection”, the abnormality notification and management screen unit transmits a push notification to a mobile terminal of the maintenance person. The abnormality notification and management screen unit utilizes WebGL technology in a drawing process of the management screen. The abnormality notification and management screen unit renders a three-dimensional model indicating an equipment layout in the factory. The abnormality notification and management screen unit superimposes and displays an abnormality occurrence location as a heat map on this three-dimensional model. The abnormality notification and management screen unit executes such dynamic information routing and advanced visualization processing. The abnormality notification and management screen unit enables intuitive situation grasping different from a simple text-based alert. The abnormality notification and management screen unit brings about technical effects of shortening a response time at a time of an abnormality occurrence and preventing a secondary disaster by this process. The abnormality notification and management screen unit is applicable to a manufacturing base having a vast site or a central monitoring center that supervises a plurality of factories.

The data accumulation unit securely stores all video data, sensor data, abnormality detection histories, response histories, maintenance histories, equipment update histories, worker change histories, workpiece lot histories, process change histories, and the like for a long period of time. For example, they can be utilized as re-verification of a past abnormality occurrence case, relearning of an AI model, trouble cause analysis, a process improvement proposal, basis data for a capital investment plan, a teaching material for worker education, an external audit response material, and a quality assurance material. For example, when a similar abnormality occurs in a plurality of robots at the same time, the AI can automatically extract a common factor and reflect it in risk management and a preventive maintenance plan of the entire equipment. For example, using a video clip, a sensor graph, and a response history at a time of an abnormality occurrence, they can also be utilized for education of a maintenance person, manual creation, and external audit response. Specifically, the data accumulation unit is configured by combining a distributed database system and an object storage. The data accumulation unit processes unstructured data and structured data sent from each information acquisition unit in parallel. The data accumulation unit encodes a video tensor, which is unstructured data, using a compression algorithm. The data accumulation unit divides the encoded video data into chunks and stores them in the object storage. The data accumulation unit converts a sensor time-series array, which is structured data, into a columnar format. The data accumulation unit stores the data in this columnar format in a time-series database. The data accumulation unit executes an indexing process on the stored data. The data accumulation unit utilizes a natural language processing model in this indexing process. The natural language processing model receives text data of an abnormality response history as an input. The natural language processing model extracts a keyword vector from the text data. The keyword vector is, for example, an array of 512-dimensional floating-point numbers. The natural language processing model stores this keyword vector as an output in a vector database. The data accumulation unit speeds up a subsequent similar case search process using this vector database. The data accumulation unit calculates a cosine similarity between a search query and the stored keyword vector. The data accumulation unit executes such unconventional multidimensional data management and vector search processing. The data accumulation unit makes it possible to instantly extract necessary information from a huge amount of history data. The data accumulation unit brings about technical effects of a dramatic improvement in data search speed and optimization of storage capacity by this process. The data accumulation unit is applicable to a quality assurance department or a maintenance department that utilizes past trouble cases as a knowledge base.

Furthermore, the generative AI analysis unit also realizes continuous relearning and self-optimization of an AI model. For example, when an actual failure cause and a response result are recorded after an abnormality occurrence, the AI learns the information and automatically improves future abnormality detection accuracy and accuracy of a recommended response procedure. For example, it automatically learns a work pattern for each process, an equipment update, a seasonal variation, a change in an operating environment, a skill difference of a worker, a material and a lot difference of a workpiece, and the like, and can always keep an abnormality detection model and a risk prediction model in a latest state. For example, the AI can comprehensively analyze an abnormality occurrence tendency of the entire equipment, a maintenance history, a process change history, a worker change history, and the like, automatically generate a future risk and an improvement proposal, and notify an administrator of an advance warning and an improvement proposal. Specifically, the generative AI analysis unit implements a continuous learning pipeline. The generative AI analysis unit periodically acquires a new learning dataset from the data accumulation unit. The learning dataset includes, for example, an image tensor, a sensor time-series array, and a correct label given by a maintenance person collected in the latest one month. The correct label is, for example, a one-hot vector indicating an actual failure cause. The generative AI analysis unit inputs this learning dataset to a neural network for relearning. The neural network for relearning holds an existing weight parameter as an initial value. The neural network for relearning executes a forward propagation calculation on the input data. The neural network for relearning outputs a predicted label from an output layer. The predicted label is, for example, a vector indicating a probability distribution of each failure cause. The generative AI analysis unit calculates a Kullback-Leibler divergence between the predicted label and the correct label. The generative AI analysis unit executes a backpropagation method using this divergence as a loss function. The generative AI analysis unit minutely updates the weight parameter of the network using a gradient descent method. The generative AI analysis unit adopts a replay method of mixing past important data at a certain ratio in order to prevent catastrophic forgetting in this update process. The generative AI analysis unit verifies the updated weight parameter using an evaluation dataset. The generative AI analysis unit replaces a model in a production environment with a new model when an evaluation score satisfies a standard. The generative AI analysis unit executes such autonomous parameter update and model evaluation processing. The generative AI analysis unit dynamically adapts to an environmental change and aging degradation of equipment. The generative AI analysis unit brings about technical effects of maintaining long-term detection accuracy and preventing model obsolescence by this process. The generative AI analysis unit is applicable to a production environment with severe seasonal variations or a high-mix low-volume production line where setup changes are frequently performed.

As described above, the embodiment of the present invention multidimensionally monitors and analyzes an operation status, a work operation, a machine state, a surrounding environment, a worker operation, a workpiece state, a process history, a maintenance history, and the like of various robots and equipment in a factory in real time, realizes advanced abnormality detection, sign detection, risk prediction, and response optimization using generative AI, and comprehensively and practically realizes immediate notification to an administrator or a maintenance person, visualization of an overall status on a management screen, recording of a response history at a time of an abnormality occurrence, and long-term storage of all data and utilization for AI model relearning, and is an extremely useful system capable of enabling early discovery of a complex abnormality or sign, which has been difficult with conventional technology, and significant improvement in safety, efficiency, maintainability, quality assurance, education, and audit response of an entire process. Specifically, the system couples the above-described functional units via a high-speed internal bus and a secure virtual private network. The system includes an orchestration engine that supervises the whole. The orchestration engine constantly monitors load statuses of a CPU and a GPU of each functional unit. The orchestration engine acquires system metrics indicating the load statuses as a time-series vector. The time-series vector is, for example, a multidimensional array including a CPU usage rate, a memory usage amount, and a network bandwidth of each node. The orchestration engine inputs this time-series vector to a reinforcement learning agent for resource allocation. The reinforcement learning agent learns an optimal resource allocation policy based on a Markov decision process. The reinforcement learning agent calculates an action value function from the input time-series vector. The reinforcement learning agent outputs a control command instructing scale-out or scale-in of a container as a calculation result. The control command is, for example, an integer value that increases or decreases the number of replicas of a specific inference node. The system transmits this control command to a subsequent container management platform. The container management platform dynamically rearranges computing resources in accordance with the instruction. The system executes such unconventional autonomous resource optimization processing. The system continues analysis processing without delay even for a sudden increase in data amount. By this processing, the system brings about technical effects of improving fault tolerance of the entire system and maximizing utilization efficiency of computing resources. The system is applicable to a mission-critical manufacturing infrastructure that is required to operate non-stop 24 hours a day, 365 days a year.

### System Configuration

The system according to the present embodiment includes a camera information acquisition unit, a sensor information acquisition unit, a generative AI analysis unit, an abnormality notification and management screen unit, a data accumulation unit, a communication management unit, a user authentication unit, and a privacy protection unit. The camera information acquisition unit constantly captures a robot operation video, an overall video of a work site, a worker operation, a workpiece transport status, an AGV travel route, a contact risk between a person and a robot during maintenance work, and the like at multiple angles, high resolution, and a high frame rate from various cameras such as a fixed type, a movable type, a wide-angle type, an infrared type, a night vision type, a high-speed shooting type, and a camera with a zoom function installed in an automated line, an assembly cell, a transport system, a picking area, a welding process, a painting process, an inspection process, a palletizing area, an AGV travel path, a worker coexistence area, a maintenance and inspection space, and the like in a factory, and transmits video data to a server in real time. For example, an operation of a robot arm in an assembly cell, a workpiece gripping/releasing operation of an end effector, a picking/palletizing operation of a collaborative robot on a transport line, a torch trajectory and weld bead formation in a welding process, a visual inspection operation and a defective product discharge operation in an inspection process, an AGV travel route and an obstacle avoidance operation, a cooperative operation with a worker, a human contact risk during maintenance work, and the like are recorded in detail. At night or in a dark place, an infrared camera or a night vision camera is used to accurately capture movements of a robot and a workpiece even in an environment with insufficient lighting, and a movable camera or a camera with a zoom function is used to automatically switch a gaze point when an abnormality occurs to acquire a detailed video. Specifically, the camera information acquisition unit is composed of a plurality of camera devices and an edge gateway that controls them. The edge gateway receives raw video data streamed from each camera. The edge gateway executes compression processing using a hardware encoder on the received raw video data. The edge gateway decodes the compressed video data frame by frame to generate an image tensor. The image tensor is, for example, a three-dimensional array having a width of 1920 pixels, a height of 1080 pixels, and RGB values of 3 channels. The edge gateway inputs this image tensor to an inference accelerator on an edge side. The inference accelerator executes a lightweight object detection neural network. The object detection neural network extracts a feature map from the input image tensor. The object detection neural network outputs a joint position of a robot arm and skeletal coordinates of a worker from the feature map. The skeletal coordinates are, for example, a matrix including XY coordinates and reliability scores of 17 key points of a human body. The edge gateway passes this skeletal coordinate data to a subsequent abnormality determination module. The abnormality determination module analyzes a chronological change in the skeletal coordinates to determine a fall of a worker or an intrusion into a dangerous area. The edge gateway immediately activates a local alarm device when detecting a danger. The edge gateway executes such low-latency image analysis and immediate control on the edge side. The edge gateway realizes real-time safety assurance independent of a communication delay to a cloud server. By this processing, the edge gateway brings about technical effects of improving worker safety and saving a communication bandwidth. The edge gateway is applicable to a collaborative robot cell where a human and a robot work in the same space.

The sensor information acquisition unit acquires an operation status, machine state data, and surrounding environment data of a robot at regular intervals or in real time from a wide variety of sensors such as an acceleration sensor, a temperature sensor, a current sensor, a vibration sensor, a position sensor, a torque sensor, an encoder, a proximity sensor, a pressure sensor, a force sensor, a gyro sensor, and an environmental sensor installed on each robot main body, an end effector, a control panel, and peripheral equipment, and transmits them to the server. For example, an acceleration sensor detects minute vibrations and impacts of a robot arm, an end effector, a transport device, and an AGV, and extracts signs of bearing wear, gear loss, poor balance, external impact, and the like. A temperature sensor monitors a temperature rise of a motor, a speed reducer, a control panel, a welding torch, a painting nozzle, and the like, and early detects a cooling failure, a burnout risk, and a performance drop due to overheating. A current sensor detects abnormal fluctuations in a drive current, an inrush current, a welding current, a painting pump current, and the like of each axis, and identifies an overload, a short circuit, a control abnormality, and deterioration of consumable parts. A torque sensor monitors a load fluctuation and an excessive torque of an arm, a gripper, and a transport device, and extracts a workpiece gripping mistake, mechanical interference, foreign matter biting, and overloading. An encoder detects a position shift, backlash, a drop in repeatability, and an AGV travel trajectory deviation, and grasps a control system abnormality, mechanical deterioration, and guide wear. A proximity sensor and a pressure sensor monitor a workpiece gripping state, a collision risk, a contact risk with a worker or other equipment, load collapse during palletizing, and a workpiece drop during picking in real time. A force sensor measures a pressing force of a welding torch or a painting nozzle, a gripping force of a gripper, and a contact pressure of an inspection probe, and determines whether an appropriate work is being performed. An environmental sensor acquires fluctuations in temperature, humidity, noise, illuminance, dust concentration, and the like, and analyzes an influence on robot operation and an abnormality occurrence factor. Specifically, the sensor information acquisition unit includes a programmable logic controller and a data logger connected to various sensors. The data logger samples an analog signal of a sensor at a high cycle in milliseconds. The data logger converts the sampled data into a digital value and applies low-pass filter processing for noise removal. The data logger formats the filtered data into a multidimensional time-series vector. The time-series vector is, for example, an 8-dimensional numerical array including 3-axis acceleration, 3-axis gyro, temperature, and current value. The data logger inputs this time-series vector to an abnormality detection algorithm on the edge side. The abnormality detection algorithm adopts an autoencoder-type neural network. The autoencoder compresses the input time-series vector into a low-dimensional latent space. The autoencoder reconstructs and outputs the original time-series vector from the compressed latent representation. The output data is the same 8-dimensional numerical array as the input. The data logger calculates a reconstruction error between the input vector and the output vector. The data logger passes this reconstruction error as an abnormality degree score to a subsequent cloud transmission module. The cloud transmission module selectively transmits only a data segment whose abnormality degree score exceeds a predetermined threshold value to the cloud server. The sensor information acquisition unit executes such unconventional data compression and abnormality scoring on the edge side. The sensor information acquisition unit extracts only truly valuable information from a huge amount of sensor data. By this processing, the sensor information acquisition unit brings about technical effects of reducing a storage cost on a cloud side and speeding up analysis processing. The sensor information acquisition unit is applicable to a large-scale machining center or a press processing line in which thousands of sensors operate.

The generative AI analysis unit integrally and multilaterally analyzes multidimensional data obtained from the camera information acquisition unit and the sensor information acquisition unit on the server, extracts an operation pattern and a work procedure of the robot from a camera video, and determines an operation speed and acceleration of an arm, smoothness of a trajectory, a gripping/releasing timing of a workpiece, a trajectory deviation of a welding torch, a workpiece drop or miss during picking, a defective product detection operation in an inspection process, a disturbance of a painting pattern, an AGV travel route deviation, an inappropriate operation of a worker, and the like with high accuracy. It extracts a sign of bearing wear or gear loss from an abnormality pattern of an acceleration waveform, a motor burnout risk from a simultaneous fluctuation of a temperature rise and a current value, an overload or mechanical interference from a combination of a torque fluctuation and a position shift, a gripping mistake or a workpiece drop from an abnormal value of a pressure sensor, a contact risk with a person or other equipment from a reaction of a proximity sensor, a work defect or equipment damage risk from an abnormal value of a force sensor, a trouble risk due to an operating environment deterioration or a dust/temperature/humidity abnormality from an abnormal value of an environmental sensor, and the like by multivariate analysis. It also learns past normal operation data, an abnormality occurrence history, an aging degradation tendency for each robot, a work pattern for each process, a fluctuation of a season and an operating environment, an equipment update history, a maintenance history, a skill difference of a worker, a type and a lot difference of a workpiece, and the like, and automatically generates an individually optimized abnormality detection algorithm. When a plurality of abnormalities occur simultaneously or when a pattern that is a sign of an abnormality occurrence is detected, it automatically determines a severity level and an urgency level, and automatically generates an optimal response procedure and notification details. The AI learns a response history at a time of an abnormality occurrence and an actual failure cause, and automatically improves future abnormality detection accuracy and accuracy of a recommended response procedure. Specifically, the generative AI analysis unit operates on a large-scale parallel computing cluster constructed on a cloud server. The generative AI analysis unit executes data alignment processing for synchronizing an image tensor from the camera information acquisition unit and a time-series vector from the sensor information acquisition unit. The generative AI analysis unit inputs the synchronized multimodal data to a spatiotemporal graph convolutional network. The spatiotemporal graph convolutional network constructs a graph structure in which each joint and sensor of the robot are nodes and physical connection relationships are edges. The spatiotemporal graph convolutional network learns a spatial dependency and a temporal change between nodes from the input data. The spatiotemporal graph convolutional network updates a hidden state vector of each node. The spatiotemporal graph convolutional network inputs a final hidden state vector to a fully connected layer. The spatiotemporal graph convolutional network outputs a health score indicating a health state of the entire equipment and an abnormality occurrence probability from the fully connected layer. The health score is, for example, a continuous value from 0 to 100. The abnormality occurrence probability is an output value of a softmax function for each failure mode. The generative AI analysis unit inputs this output result to a subsequent natural language generation module. The natural language generation module outputs a text explaining a reason for the abnormality using a transformer-based language model. The text is, for example, a character string “The vibration frequency of the second axis motor has shifted to a high frequency band, and initial wear of the bearing is suspected.” The generative AI analysis unit executes such multimodal analysis and natural language generation based on an unconventional graph structure. The generative AI analysis unit presents an internal state of a complex mechanical system in a form that is easy for a human to understand. By this processing, the generative AI analysis unit brings about technical effects of improving efficiency of maintenance work and minimizing downtime. The generative AI analysis unit is applicable to monitoring of an articulated robot having a complex link mechanism or a parallel link mechanism.

When an abnormality, a failure sign, a work efficiency drop, a dangerous behavior, a maintenance necessity, or the like is detected by the generative AI analysis unit, the abnormality notification and management screen unit immediately transmits a detailed notification including identification information of a corresponding robot, abnormality details, an occurrence time, a recommended response procedure, a latest video clip and sensor graph, a past similar case, a severity level, an urgency level determination, and the like to a terminal of an administrator or a maintenance person. When an operation speed drop and an acceleration abnormality of an arm are simultaneously detected, it transmits a notification such as “Operation speed drop and vibration abnormality detected in robot X of assembly cell A, bearing wear sign, inspection within 48 hours recommended.” When a torch trajectory deviation and a temperature rise simultaneously occur in a welding process, it transmits a notification such as “Torch trajectory deviation and motor temperature rise detected in robot Y of welding cell B, cooling system inspection and torch trajectory correction recommended.” When an AGV travel route deviation and an obstacle detection simultaneously occur, it transmits a notification such as “Travel route deviation and obstacle detection in AGV Z of transport area C, route resetting and obstacle removal recommended.” On a management screen, an operation status of all robots, an abnormality occurrence history, a maintenance recommendation, a work efficiency transition, a past response history, a risk prediction by AI, an abnormality occurrence tendency by process, a maintenance history for each equipment, an abnormality occurrence tendency for each worker, a defect rate transition for each workpiece, and the like are visualized in a list and a graph, which can be utilized for improving safety and productivity at a site, an equipment maintenance plan and a process improvement proposal, worker education, and an external audit response. Specifically, the abnormality notification and management screen unit is composed of a front-end web application and a back-end API server. The back-end API server receives a JSON payload including a health score, an abnormality occurrence probability, and an explanatory text output from the generative AI analysis unit. The back-end API server analyzes this JSON payload and collates it with a profile database of a notification target person. The back-end API server determines an optimal notification channel and message format based on a collation result. The back-end API server generates a push notification payload in accordance with the determined format. The push notification payload is structured data including, for example, a destination device token, a title, a body text, and a URL link to a detailed screen. The back-end API server transmits this push notification payload to an external messaging service. The front-end web application receives data in real time from the back-end API server using WebSocket communication. The front-end web application dynamically updates a graph and a 3D model on a dashboard using the received data. The front-end web application executes rendering processing of, for example, blinking a 3D model of a robot in which an abnormality has occurred in red. The abnormality notification and management screen unit executes such unconventional dynamic routing and real-time drawing processing. The abnormality notification and management screen unit transmits accurate information to a worker at a site or an administrator at a remote location without delay. By this processing, the abnormality notification and management screen unit brings about technical effects of speeding up incident response and smoothing information sharing. The abnormality notification and management screen unit is applicable to an integrated monitoring center of a plurality of factories deployed globally.

The data accumulation unit securely stores all video data, sensor data, abnormality detection histories, response histories, maintenance histories, equipment update histories, worker change histories, workpiece lot histories, process change histories, and the like for a long period of time. They can be utilized as basis data for re-verification of a past abnormality occurrence case, relearning of an AI model, trouble cause analysis, a process improvement proposal, and a capital investment plan, a teaching material for worker education, an external audit response material, and a quality assurance material. When a similar abnormality occurs in a plurality of robots at the same time, the AI can automatically extract a common factor and reflect it in risk management and a preventive maintenance plan of the entire equipment. Using a video clip, a sensor graph, and a response history at a time of an abnormality occurrence, they can also be utilized for education of a maintenance person, manual creation, and an external audit response. Specifically, the data accumulation unit adopts a hierarchical storage architecture consisting of a hot data layer, a warm data layer, and a cold data layer. The data accumulation unit stores latest video data and sensor data in a hot data layer composed of a high-speed solid state drive. The data accumulation unit provides high-speed query processing using an in-memory database for data stored in the hot data layer. The data accumulation unit automatically migrates data for which a certain period has elapsed to a hard disk drive of a warm data layer. The data accumulation unit applies data downsampling and a compression algorithm in this migration processing. The data accumulation unit executes processing of thinning out, for example, 1000 samples of sensor data per second to 10 samples per second. The data accumulation unit further archives older data to a cloud object storage of a cold data layer. The data accumulation unit assigns a metadata tag to the archived data. The metadata tag is a key-value pair such as “robot model number”, “type of abnormality that occurred”, and “responded worker ID”, for example. The data accumulation unit registers this metadata tag in an index of a search engine. The data accumulation unit supports subsequent processing of extracting a past similar case at high speed using a search engine. The data accumulation unit executes such unconventional hierarchical data lifecycle management and metadata index processing. The data accumulation unit maintains search performance while optimizing a storage cost of a huge amount of industrial data. By this processing, the data accumulation unit brings about technical effects of reducing a storage cost and promoting data utilization. The data accumulation unit is applicable to an aerospace industry and a medical device manufacturing industry in which retention of traceability data for several years is obliged.

The communication management unit stably and securely controls data communication among a camera, a sensor, a server, and a management terminal, and automatically switches to a backup line in an event of a network failure to prevent data loss and a notification delay. The user authentication unit introduces a multilayered authentication method such as ID/password authentication, biometric authentication, two-step authentication, terminal authentication, and access authority management when an administrator or a maintenance person accesses a management screen or a notification system, thereby ensuring security. The privacy protection unit takes various privacy protection measures such as anonymization processing, masking processing, access log management, clarification of a data use purpose, user consent acquisition, and third-party provision restriction for personal information and confidential information such as video data, sensor data, and a response history. Specifically, the communication management unit dynamically constructs a virtual dedicated communication path using a software-defined network technology. The communication management unit constantly monitors a network delay and a packet loss rate, and automatically detours traffic to an alternative path when quality deteriorates. The user authentication unit implements a dynamic access control module based on a zero-trust architecture. Upon receiving a user login request, the dynamic access control module evaluates a security state of a device and an IP address of an access source in addition to input authentication information. The dynamic access control module inputs these evaluation indexes as a multidimensional vector to a neural network for risk determination. The neural network for risk determination outputs a validity score of an access request from the input vector. The validity score is, for example, a continuous value from 0.0 to 1.0. The user authentication unit executes an additional request for multi-factor authentication or blocking of access when this validity score falls below a threshold value. The privacy protection unit detects a face of a person and a name tag of a worker included in video data in real time. The privacy protection unit uses a semantic segmentation model for this detection processing. The privacy protection unit executes masking processing of replacing pixel data of a detected area with a noise pattern based on an irreversible hash value. The system executes such unconventional dynamic network control, AI-driven risk determination, and real-time masking processing. The system achieves both advanced security and privacy protection. By this processing, the system brings about technical effects of defense against a cyber attack and compliance observance. The system is applicable to a prototype line of a highly confidential new product and a distribution center handling personal information.

Specific examples of a prompt sentence to be read by the generative AI when implementing the present invention include “Integrally analyze a camera video in a factory and various sensor data (acceleration, temperature, current, vibration, position, torque, pressure, proximity, etc.) of a robot, detect an arm operation abnormality, a failure sign, a work efficiency drop, a dangerous behavior, a process deviation, a human contact risk, a maintenance necessity, and the like with high accuracy, automatically determine a severity level, and automatically generate optimal notification details and a recommended response procedure,” “Learn a past abnormality occurrence history, operation data, and a process pattern, predict a future failure risk and a work efficiency drop risk, and automatically generate an advance warning and an improvement proposal to an administrator,” and the like. Specifically, the system includes a prompt engineering module that dynamically generates and inputs a prompt sentence to the generative AI analysis unit. The prompt engineering module implements a template engine that embeds a state variable of the system and a current value of a sensor into a placeholder. The prompt engineering module converts structured data such as “Target equipment: robot arm A, current temperature: 85 degrees, vibration frequency: 120 Hz” into a natural language context sentence. The prompt engineering module combines this context sentence and a task instruction sentence to generate a final prompt character string. The prompt character string is, for example, lengthy text data extending to thousands of tokens. The prompt engineering module passes this prompt character string to an input layer of a large language model. The large language model calculates a dependency between each word in the prompt using a self-attention mechanism of a transformer architecture. The large language model executes inference based on the input prompt, and sequentially generates and outputs a token string of an answer text. The output answer text includes a specific action plan such as “The current combination of temperature and vibration shows 95% similarity to a pattern immediately before seizure of a motor bearing in a past case database. Immediately stop the line and check a cooling fan and a lubrication state of the bearing.” The system inputs this output text to a syntax analysis module, and executes subsequent processing of extracting an executable control command and a notification object. The system executes such unconventional dynamic prompt generation and structuring processing of a natural language inference result. The system causes a general-purpose language model to function as an advanced expert system specialized for a specific industrial domain. By this processing, the system brings about a technical effect that even an operator without specialized knowledge can perform advanced troubleshooting. The system is applicable to a local small-to-medium-sized factory or an overseas production base where a shortage of skilled engineers is an issue.

### Implementation Steps

Step 1: Acquisition and transmission of camera video

Various cameras such as a fixed type, a movable type, a wide-angle type, an infrared type, a night vision type, a high-speed shooting type, and a camera with a zoom function installed in an automated line, an assembly cell, a transport system, a picking area, a welding process, a painting process, an inspection process, a palletizing area, an AGV travel path, a worker coexistence area, a maintenance and inspection space, and the like in a factory constantly shoot a robot operation video, an overall video of a work site, a worker operation, a workpiece transport status, an AGV travel route, a contact risk between a person and a robot during maintenance work, and the like at multiple angles, high resolution, and a high frame rate, and transmit video data to a server in real time. For example, an operation of a robot arm and a workpiece gripping/releasing operation of an end effector in an assembly cell, a picking/palletizing operation of a collaborative robot on a transport line, a trajectory of a torch and welding bead formation in a welding process, a visual inspection operation and a defective product discharge operation in an inspection process, a travel route and an obstacle avoidance operation of an AGV, a cooperative operation with a worker, a human contact risk during maintenance work, and the like are recorded in detail. At night or in a dark place, an infrared camera or a night vision camera is used to accurately capture movements of a robot and a workpiece even in an environment with insufficient lighting, and a movable camera or a camera with a zoom function is used to automatically switch a gaze point when an abnormality occurs to acquire a detailed video. Specifically, in this Step 1, the camera information acquisition unit activates a video capture module resident as a daemon process on an edge device. This video capture module acquires raw video data into a main memory using direct memory access transfer from a hardware interface of the camera. This video capture module stores the acquired raw video data in a frame buffer. This video capture module executes color space conversion processing on the data in the frame buffer to convert a YUV format into an RGB format image tensor. The image tensor is, for example, a four-dimensional array having a batch size of 1, a height of 1080, a width of 1920, and 3 channels. This video capture module inputs this image tensor to an inference engine on an edge side. This inference engine extracts a region of interest from the image tensor using a lightweight convolutional neural network. This inference engine outputs bounding box coordinates and a class probability of the region of interest. The class probability is a confidence score for a category such as “robot arm”, “worker”, and “AGV”, for example. Based on this output result, this video capture module executes preprocessing of cropping only a frame including the region of interest and adjusting a resolution. This video capture module encodes the preprocessed image tensor in an H.265 standard to generate a video stream. This video capture module transmits this video stream to a cloud server using a secure real-time transfer protocol. This Step 1 executes such unconventional region of interest extraction and adaptive encoding processing on the edge side. This Step 1 efficiently collects only high-resolution important video without compressing a network bandwidth. This Step 1 brings about technical effects of reducing an analysis load on a subsequent cloud side and reducing a communication cost by this processing. This Step 1 is applicable to a large-scale automobile assembly factory in which hundreds of cameras operate simultaneously.
Step 2: Acquisition and transmission of sensor data

An operation status, machine state data, and surrounding environment data of a robot are acquired at regular intervals or in real time from a wide variety of sensors such as an acceleration sensor, a temperature sensor, a current sensor, a vibration sensor, a position sensor, a torque sensor, an encoder, a proximity sensor, a pressure sensor, a force sensor, a gyro sensor, and an environmental sensor installed on each robot main body, an end effector, a control panel, and peripheral equipment, and are transmitted to the server. For example, an acceleration sensor detects minute vibrations and impacts of a robot arm, an end effector, a transport device, and an AGV, and extracts signs of bearing wear, gear loss, poor balance, external impact, and the like. A temperature sensor monitors a temperature rise of a motor, a speed reducer, a control panel, a welding torch, a painting nozzle, and the like, and detects a cooling failure, a burnout risk, and a performance drop due to overheating at an early stage. A current sensor detects abnormal fluctuations in a drive current, an inrush current, a welding current, a painting pump current, and the like of each axis, and identifies an overload, a short circuit, a control abnormality, and deterioration of consumable parts. A torque sensor monitors a load fluctuation and an excessive torque of an arm, a gripper, and a transport device, and extracts a workpiece gripping mistake, mechanical interference, foreign matter biting, and overloading. Specifically, in this Step 2, the sensor information acquisition unit executes a data collection service that communicates with each sensor node via a fieldbus network. This data collection service periodically transmits a polling request to each sensor node and receives a response packet. This data collection service extracts a raw sensor value subjected to analog-to-digital conversion from a payload of the received packet. This data collection service multiplies the extracted raw sensor value by a calibration coefficient to convert it into a real value having a physical unit. This data collection service writes the converted real value together with a time stamp into an in-memory buffer of a time-series database. This data collection service generates a time-series matrix while sliding the data in the in-memory buffer with a constant window size. The time-series matrix is, for example, a two-dimensional array having 500 rows and columns of the number of sensors, obtained by sampling data for the past 5 seconds at 10-millisecond intervals. This data collection service inputs this time-series matrix to an abnormality detection model on the edge side. This abnormality detection model is a hybrid neural network combining a one-dimensional convolutional layer and a long short-term memory layer. This abnormality detection model extracts temporal and spatial features from the input time-series matrix. This abnormality detection model outputs a predicted value at a next time step of each sensor based on the extracted features. The predicted value is, for example, a vector of expected real values of each sensor. This data collection service calculates a residual between the output predicted value and an actual observation value, and assigns an abnormality flag to the data segment when the residual exceeds a threshold value. This data collection service executes subsequent processing of preferentially transmitting the data segment to which the abnormality flag is assigned to the cloud server. This Step 2 executes such unconventional predictive modeling of time-series data and residual-based filtering processing. This Step 2 reliably captures important fluctuation data while preventing network congestion due to normal steady data. This Step 2 brings about technical effects of improving real-time performance of data collection and suppressing storage consumption on the cloud side by this processing. This Step 2 is applicable to a high-speed packaging line and a semiconductor wafer transport system that require control in units of milliseconds.
Step 3: Integrated analysis of video and sensor by generative AI

A generative AI analysis unit on the server integrally and multilaterally analyzes multidimensional data obtained from the camera information acquisition unit and the sensor information acquisition unit, extracts an operation pattern and a work procedure of the robot from a camera video, and determines an operation speed and acceleration of an arm, smoothness of a trajectory, a gripping/releasing timing of a workpiece, a trajectory deviation of a welding torch, a workpiece drop or miss during picking, a defective product detection operation in an inspection process, a disturbance of a painting pattern, a travel route deviation of an AGV, an inappropriate operation of a worker, and the like with high accuracy. A sign of bearing wear or gear loss from an abnormality pattern of an acceleration waveform, a motor burnout risk from a simultaneous fluctuation of a temperature rise and a current value, an overload or mechanical interference from a combination of a torque fluctuation and a position shift, a gripping mistake or a workpiece drop from an abnormal value of a pressure sensor, a contact risk with a person or other equipment from a reaction of a proximity sensor, a work defect or equipment damage risk from an abnormal value of a force sensor, a trouble risk due to deterioration of an operating environment or an abnormality in dust, temperature, and humidity from an abnormal value of an environmental sensor, and the like are extracted by multivariate analysis. The generative AI also learns past normal operation data, an abnormality occurrence history, an aging degradation tendency for each robot, a work pattern for each process, a fluctuation of a season and an operating environment, an equipment update history, a maintenance history, a skill difference of a worker, a type and a lot difference of a workpiece, and the like, and automatically generates an individually optimized abnormality detection algorithm. As a specific example of a prompt sentence to be read by the generative AI, “Integrally analyze a camera video in a factory and various sensor data (acceleration, temperature, current, vibration, position, torque, pressure, proximity, etc.) of a robot, detect an arm operation abnormality, a failure sign, a work efficiency drop, a dangerous behavior, a process deviation, a human contact risk, a maintenance necessity, and the like with high accuracy, automatically determine a severity level, and automatically generate optimal notification details and a recommended response procedure” can be cited. Specifically, in this Step 3, the generative AI analysis unit executes a multimodal inference pipeline using a GPU cluster on the cloud server. This generative AI analysis unit decodes the video stream received in Step 1 to restore a sequence of image tensors. This generative AI analysis unit normalizes the time-series matrix received in Step 2 to generate a sensor feature vector. This generative AI analysis unit inputs the sequence of image tensors to a three-dimensional convolutional neural network to extract a spatiotemporal visual feature vector. This generative AI analysis unit inputs this visual feature vector and the sensor feature vector to a concatenation layer to generate an integrated feature vector. The integrated feature vector is, for example, a 2048-dimensional high-dimensional vector. This generative AI analysis unit inputs this integrated feature vector to a transformer-based abnormality classification model. This abnormality classification model learns a complex correlation between visual information and sensor information using a self-attention mechanism. This abnormality classification model outputs a class probability distribution of an abnormality and a severity score of the abnormality from the input integrated feature vector. The class probability distribution is, for example, an array of softmax values for each class such as “normal”, “bearing wear”, and “arm interference”. The severity score is, for example, a continuous value from 0.0 to 1.0. This generative AI analysis unit executes subsequent processing of inputting this output result to a rule-based determination engine. When the severity score exceeds a set threshold value, this determination engine activates a prompt generation module to cause a large language model to generate a detailed response procedure. This Step 3 executes such unconventional multimodal feature fusion and correlation analysis in a high-dimensional space. This Step 3 accurately identifies a complex abnormality that cannot be determined only by video or only by a sensor. This Step 3 brings about technical effects of improving comprehensiveness of abnormality detection and dramatically reducing a false positive rate by this processing. This Step 3 is applicable to an assembly process of a cell production system in which a plurality of robots cooperate to perform a complex work.
Step 4: Abnormality notification and visualization on management screen

When an abnormality, a failure sign, a work efficiency drop, a dangerous behavior, a maintenance necessity, or the like is detected by the generative AI analysis unit, an abnormality notification and management screen unit immediately transmits a detailed notification including identification information of a corresponding robot, abnormality details, an occurrence time, a recommended response procedure, a latest video clip and sensor graph, a past similar case, a severity level, an urgency level determination, and the like to a terminal of an administrator or a maintenance person. On the management screen, an operation status of all robots, an abnormality occurrence history, a maintenance recommendation, a work efficiency transition, a past response history, a risk prediction by AI, an abnormality occurrence tendency by process, a maintenance history for each equipment, an abnormality occurrence tendency for each worker, a defect rate transition for each workpiece, and the like are visualized in a list and a graph, and can be utilized for improving safety and productivity at a site, an equipment maintenance plan, a process improvement proposal, worker education, and external audit response. Specifically, in this Step 4, the abnormality notification and management screen unit asynchronously receives an analysis result event from the generative AI analysis unit via a message broker. This abnormality notification and management screen unit extracts an abnormality class, a severity score, and a response procedure text from the received event data. This abnormality notification and management screen unit refers to a notification routing table using this extracted data to acquire a list of user IDs and device IDs of transmission destinations. This abnormality notification and management screen unit generates and transmits an API request to a push notification service based on the acquired list. The API request is, for example, an HTTP POST request including a payload in a JSON format. At the same time, this abnormality notification and management screen unit push-delivers update data to a front-end application of the management screen using server-sent events. This front-end application dynamically rewrites a document object model on a browser based on the received update data. This front-end application changes, for example, an icon of a robot arranged on a floor map of a factory from green to red, and applies a blinking animation. When a user clicks the icon, this front-end application draws a latest video clip and a time-series graph of sensor data of the corresponding robot as a modal window. This abnormality notification and management screen unit executes such an unconventional event-driven architecture and real-time document object model update processing. This abnormality notification and management screen unit reflects a state change to a large number of clients all at once without delay. This Step 4 brings about technical effects of improving situational awareness capability of a site worker and speeding up an initial response by this processing. This Step 4 is applicable to a chemical plant or a large-scale logistics warehouse in which a large number of facilities are scattered in a vast site.
Step 5: Data accumulation and AI model relearning

A data accumulation unit securely stores all video data, sensor data, abnormality detection histories, response histories, maintenance histories, equipment update histories, worker replacement histories, workpiece lot histories, process change histories, and the like for a long period of time. They can be utilized as basis data for re-verification of a past abnormality occurrence case, AI model relearning, trouble cause analysis, a process improvement proposal, a capital investment plan, a teaching material for worker education, an external audit response material, and a quality assurance material. When a similar abnormality occurs in a plurality of robots at the same time, the AI can automatically extract a common factor and reflect it in risk management and a preventive maintenance plan of the entire equipment. Specifically, in this Step 5, the data accumulation unit executes data persistence processing using a distributed file system and a distributed database. This data accumulation unit records the abnormality event data, the video clip, the sensor data, and the user response history processed in Step 4 as one transaction in a relational database. This data accumulation unit periodically extracts this recorded data using a batch processing module. This batch processing module cleanses the extracted data, converts it into a format for machine learning, and stores it in a data lake. This data accumulation unit inputs a data set stored in this data lake to a relearning pipeline. This relearning pipeline fine-tunes weight parameters of a neural network of the generative AI analysis unit using the new data set. This relearning pipeline updates the weights so as to minimize a loss function using, for example, a stochastic gradient descent method. This relearning pipeline evaluates the updated model with a test data set and outputs an accuracy index. The accuracy index is, for example, a numerical vector including precision, recall, and an F1 score. When this accuracy index exceeds a previous model, this relearning pipeline executes subsequent processing of pushing a new model image to a container registry in a production environment. This Step 5 executes such an unconventional automated data pipeline and continuous integration/continuous deployment processing. This Step 5 constantly adapts the entire system to a latest operating environment without human intervention. This Step 5 brings about technical effects of preventing accuracy degradation of a model and reducing an operation and maintenance cost by this processing. This Step 5 is applicable to an electronic device manufacturing line in which a product life cycle is short and a manufacturing process is frequently changed.

### Specific Use Case

For example, when an articulated robot grips a plurality of workpieces and sequentially executes an assembly process in an assembly cell, the camera information acquisition unit constantly shoots an operation of a robot arm, workpiece gripping/releasing of an end effector, a transport route of a workpiece, an operation of a worker, an assembly state of a workpiece, and the like at multiple angles, high resolution, and a high frame rate, and the sensor information acquisition unit acquires minute vibrations by an acceleration sensor of a robot main body, a load fluctuation by a torque sensor, a position shift by an encoder, a motor temperature by a temperature sensor, a drive current by a current sensor, a gripping force by a pressure sensor, presence or absence of a workpiece by a proximity sensor, a pressing force by a force sensor, temperature, humidity, and noise by an environmental sensor, and the like in real time. The generative AI analysis unit extracts an operation speed and acceleration of an arm, smoothness of a trajectory, a gripping/releasing timing of a workpiece, a minute shift during assembly, an inappropriate operation of a worker, a workpiece drop or miss, a process deviation, and the like from a camera video, and extracts a bearing wear sign from an abnormality pattern of an acceleration waveform, an overload or mechanical interference from a combination of a torque fluctuation and a position shift, a motor burnout risk from a simultaneous fluctuation of a temperature rise and a current value, a gripping mistake or a workpiece drop from an abnormal value of a pressure sensor, a human contact risk from a reaction of a proximity sensor, an equipment damage risk from an abnormal value of a force sensor, an operating environment deterioration from an abnormal value of an environmental sensor, and the like from sensor data by multivariate analysis. For example, when an operation speed drop and an acceleration abnormality of an arm are simultaneously detected, a notification such as “Operation speed drop and vibration abnormality detected in robot of assembly cell, bearing wear sign, inspection within 48 hours recommended” is immediately transmitted to an administrator terminal, and on the management screen, an operation status of the corresponding robot, an abnormality occurrence history, a recommended response procedure, a past similar case, an abnormality tendency for each worker, a defect rate transition for each workpiece, and the like are visualized in a graph or a list. All data is stored in the data accumulation unit for a long period of time, and can be utilized as AI model relearning, trouble cause analysis, a process improvement proposal, a capital investment plan, worker education, an external audit response, and a quality assurance material. Specifically, this system implements a multimodal neural network that integrally processes multivariate data in an assembly cell. This system acquires a camera video as three-dimensional tensor data. This system acquires sensor data as a one-dimensional time-series array. This system executes normalization processing on these input data. This system applies a noise reduction filter. This system inputs the preprocessed video data to a convolutional neural network. This system extracts a spatial feature map from the video. This system inputs the time-series sensor data to a long short-term memory network. This system models a temporal dependency. This system combines a plurality of extracted feature vectors in a high-dimensional space. This system calculates an abnormality score through a fully connected layer. Specific input data to this neural network is a color image tensor having a resolution of 1920 by 1080. Another input data is a numerical vector of three-axis acceleration sampled at 100 hertz. Still another input data is a time-series array of a motor drive current. Specific output data from this neural network is an abnormality probability score taking a range from zero to one. Another output data is a one-hot vector indicating an abnormality category such as bearing wear or motor overheating. Still another output data is a coordinate value of a bounding box indicating an abnormal location. This processing unit compares the output abnormality probability score with a preset threshold value. This processing unit executes alert issuance processing when the score exceeds the threshold value. This processing unit transmits an emergency stop command or a deceleration command to a robot control unit. Unlike conventional rule-based threshold value determination, this system learns a non-linear correlation of multivariate data in a high-dimensional space. This system captures a minute sign of an abnormality that cannot be detected by a single sensor with high accuracy. This system significantly reduces a false positive rate. This system dramatically improves accuracy of predictive maintenance. This system brings about a technical effect of maximizing an equipment operation rate. A specific application field of this system is a precision assembly line for automobile parts. Another application field is a high-speed mounting process for an electronic board. This system allows a plurality of embodiments. This system can adopt a configuration in which a lightweight inference model is executed on an edge device side. This system can construct a distributed processing architecture in which detailed analysis by a large-scale model is executed on a cloud side. This system continuously updates weight parameters of a model using a backpropagation method. This system advances learning so as to minimize a cross-entropy error function. This system ensures diversity of learning data using a data augmentation method. This system improves generalization performance for an unknown abnormality pattern.

For example, when a robot performs automatic welding using a torch in a welding process, the camera information acquisition unit shoots a trajectory of the torch, welding bead formation, a position of a workpiece, an operation of a worker, an occurrence status of sparks and smoke during welding, and the like from multiple angles, and the sensor information acquisition unit acquires acceleration of the torch, a welding current, a torque, a temperature, a vibration, a pressure, a proximity, dust and a gas concentration by an environmental sensor, and the like. The generative AI analysis unit extracts a trajectory deviation of the torch, a disturbance of a welding bead, a position shift of a workpiece, an abnormal occurrence of sparks and smoke, a safety rule violation of a worker, and the like from a camera video, and extracts an abnormal fluctuation of a welding current, a torque fluctuation, a temperature rise, a vibration abnormality, a pressure abnormality, a human contact risk by a proximity sensor, a gas concentration abnormality by an environmental sensor, and the like from sensor data by multivariate analysis. For example, when a trajectory deviation of the torch and a temperature rise occur simultaneously, a notification such as “Torch trajectory deviation and motor temperature rise detected in robot of welding cell, cooling system inspection and torch trajectory correction recommended” is transmitted to an administrator terminal. Specifically, this system implements a spatiotemporal analysis neural network that analyzes thermal and acoustic features peculiar to a welding process. This system acquires heat distribution data of a molten pool as a two-dimensional tensor from an infrared camera. This system acquires fluctuations of a welding current and a voltage as one-dimensional waveform data. This system executes fast Fourier transform processing on these data. This system extracts a feature in a frequency domain. This system inputs the heat distribution data to a three-dimensional convolutional neural network. This system segments a formation process of a welding bead in units of pixels. This system inputs the waveform data to a one-dimensional convolutional neural network. This system detects a sign of arc interruption or spatter generation. Specific input data to this neural network is a heat map image tensor indicating a temperature gradient. Another input data is a time-series array of a welding current recorded in units of milliseconds. Still another input data is a three-dimensional coordinate vector of a torch tip. Specific output data from this neural network is a floating-point number indicating an occurrence probability of a blowhole or poor penetration. Another output data is a trajectory correction vector in units of millimeters in each axis direction of a three-dimensional orthogonal coordinate system. Still another output data is numerical data indicating a recommended value of an optimal welding voltage. This processing unit transmits the output trajectory correction vector to a robot controller in real time. This processing unit dynamically fine-tunes a position of the torch. This processing unit generates a control signal for routing the workpiece to a defective product discharge line when a defect probability exceeds a specified value. This system substitutes determination of welding quality, which has relied on tacit knowledge of a skilled worker, with mapping to a quantitative feature space. This system instantaneously detects a minute temperature change or a current disturbance that cannot be captured by human vision. This system prevents occurrence of a defective product by real-time trajectory correction. This system brings about technical effects of improving a yield and automating an inspection process. A specific application field of this system is a thick plate welding process for construction machinery. Another application field is precision laser welding for aircraft parts. This system provides a plurality of alternative methods. This system can adopt a multimodal configuration in which audio data from an acoustic sensor is converted into a mel-frequency cepstral coefficient and added to an input feature. This system can apply a method of calculating an abnormality degree only from normal data by an autoencoder using unsupervised learning. This system attempts to optimize a network using a gradient descent method. This system uses a mean square error as a loss function.

For example, when an AGV autonomously travels in a transport area, the camera information acquisition unit shoots a travel route of the AGV, an obstacle avoidance operation, a contact risk with a worker or other equipment, a loading/unloading operation of a load, and the like, and the sensor information acquisition unit acquires acceleration, a gyro, a position, a torque, a current, a temperature, a proximity, a pressure, an environmental sensor, and the like of an AGV main body. The generative AI analysis unit extracts a travel route deviation, an obstacle avoidance failure, a load drop, a safety rule violation of a worker, and the like from a camera video, and analyzes an acceleration abnormality, an excessive torque, a temperature rise, an abnormal reaction of a proximity sensor, a pressure abnormality, an abnormal value of an environmental sensor, and the like from sensor data. For example, when a travel route deviation and obstacle detection occur simultaneously, a notification such as “Travel route deviation and obstacle detection in AGV of transport area, route resetting and obstacle removal recommended” is transmitted to an administrator terminal. Specifically, this system implements a reinforcement learning-based navigation model that optimizes spatial recognition and path planning of an autonomous mobile object in a dynamic environment. This system acquires three-dimensional point cloud data of a surrounding environment from a light wave distance measuring sensor. This system acquires a depth image tensor from a stereo camera. This system acquires a numerical vector of its own speed and angular speed from odometry. This system converts the point cloud data into a voxel grid. This system executes downsampling processing. This system inputs the preprocessed spatial data to a point cloud processing neural network. This system estimates a position and a velocity vector of a dynamic obstacle. This system integrates an estimation result with a self-position estimation algorithm. This system updates a dynamic cost map of an environment in real time. Specific input data to this neural network is a point cloud tensor including tens of thousands of three-dimensional coordinates. Another input data is a 256-gradation grayscale depth image. Still another input data is a time-series array of a moving distance based on the number of rotations of a wheel. Specific output data from this neural network is numerical data in units of seconds indicating a predicted collision time with an obstacle. Another output data is a group of a plurality of waypoint coordinates constituting an avoidance route. Still another output data is a binary flag instructing an emergency stop. This processing unit immediately operates an electromagnetic brake of a motor when the output emergency stop flag is true. This processing unit calculates a steering angle and a target speed based on the group of waypoint coordinates. This processing unit issues a control command to a drive system. This system executes processing based on a Markov decision process that calculates an optimal action value from a high-dimensional environmental state space, not limited to static path following. This system generates an anticipatory avoidance action against an unpredictable movement of a human or other equipment. This system mathematically minimizes a risk of a collision accident. This system brings about a technical effect of ensuring safety while preventing a drop in transport efficiency. A specific application field of this system is swarm control of picking robots in a large-scale logistics warehouse. Another application field is an automatic transport system for drugs and specimens in a hospital. As a configuration variation, this system can introduce a cooperative multi-agent reinforcement learning model in which a plurality of autonomous mobile objects share intentions and trajectories with each other via a communication network. This system adopts a method of transfer-learning a policy network pre-learned in a simulation environment to an actual machine. This system combines a collision penalty and a destination arrival reward when designing a reward function. This system optimizes an action probability distribution using a policy gradient method.

As a specific example of a prompt sentence to be read by the generative AI, “Integrally analyze a camera video in a factory and various sensor data (acceleration, temperature, current, vibration, position, torque, pressure, proximity, etc.) of a robot, detect an arm operation abnormality, a failure sign, a work efficiency drop, a dangerous behavior, a process deviation, a human contact risk, a maintenance necessity, and the like with high accuracy, automatically determine a severity level, and automatically generate optimal notification details and a recommended response procedure”, “Learn a past abnormality occurrence history, operation data, and a process pattern, predict a future failure risk and a work efficiency drop risk, and automatically generate an advance warning and an improvement proposal to an administrator”, and the like can be cited. Specifically, this system implements a large language model-based inference engine that fuses natural language processing and time-series data analysis. This system acquires a natural language prompt from an administrator as a text token sequence. This system acquires a system log collected from equipment as structured data. This system acquires a statistical feature of sensor data as a numerical vector. This system projects a text token into an embedding vector space. This system calculates a contextual dependency between words using a self-attention mechanism. This system converts the structured data and the numerical vector into a latent representation by a dedicated encoder. This system combines a natural language query and the latent representation of the equipment data using a cross-attention mechanism. Specific input data to this neural network is a token embedding vector of thousands of dimensions. Another input data is a log file in a structured data format including an error code and a time stamp. Still another input data is a numerical array including an average value and a variance value of a temperature sensor for the past 24 hours. Specific output data from this neural network is text data in a natural language explaining a root cause of an abnormality. Another output data is an execution code in a script language format for automating a recovery work. Still another output data is an integer score from 1 to 5 indicating an urgency level of an event. This processing unit verifies the output execution code in a sandbox environment. This processing unit deploys it to an automatic execution environment after safety is confirmed. This processing unit draws the text data and the urgency level score on a user interface of an administrator dashboard. Unlike a mere keyword search or presentation of a fixed phrase, this system dynamically interprets a semantic correlation of multidimensional data by utilizing a neural network architecture equipped with a self-attention mechanism having billions of parameters. This system provides an advanced troubleshooting procedure equivalent to that of a skilled engineer even to an operator having no specialized knowledge. This system minimizes downtime of equipment. This system brings about a technical effect of eliminating personalization of a maintenance work. A specific application field of this system is operation support of an integrated monitoring center in a smart factory. Another application field is a predictive maintenance service for an industrial machine installed in a remote location. This system includes a plurality of embodiments, and can execute fine-tuning processing for additionally learning a specific technical term or an in-house manual. This system can adopt a configuration in which a latest technical document is dynamically acquired from an external database using a retrieval-augmented generation technology and added as a basis for an answer. This system incorporates a fact-checking module in a post-processing stage in order to suppress a factual error in an output. This system continuously executes optimization of a model based on human feedback using reinforcement learning.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

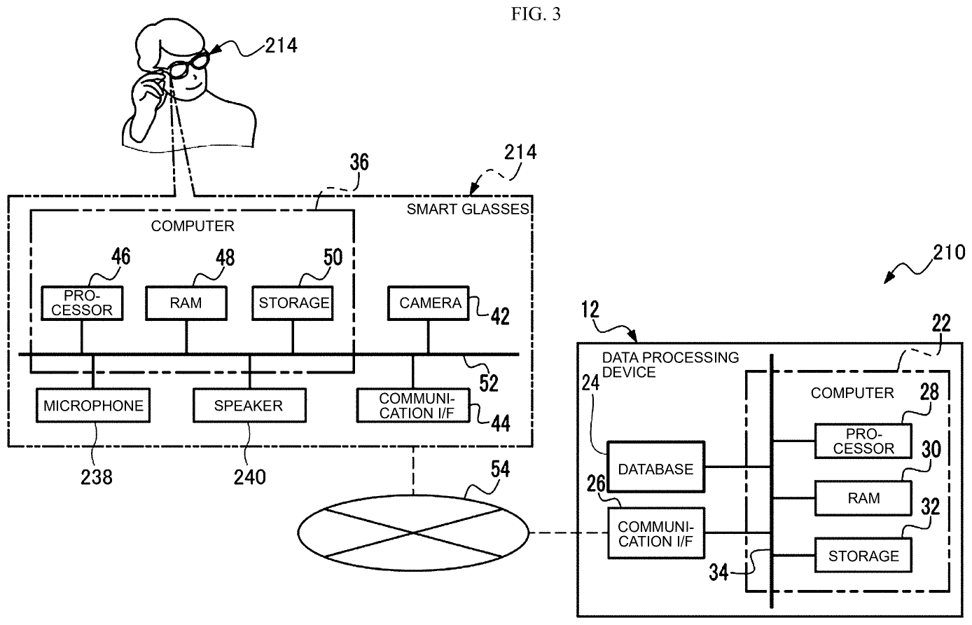

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

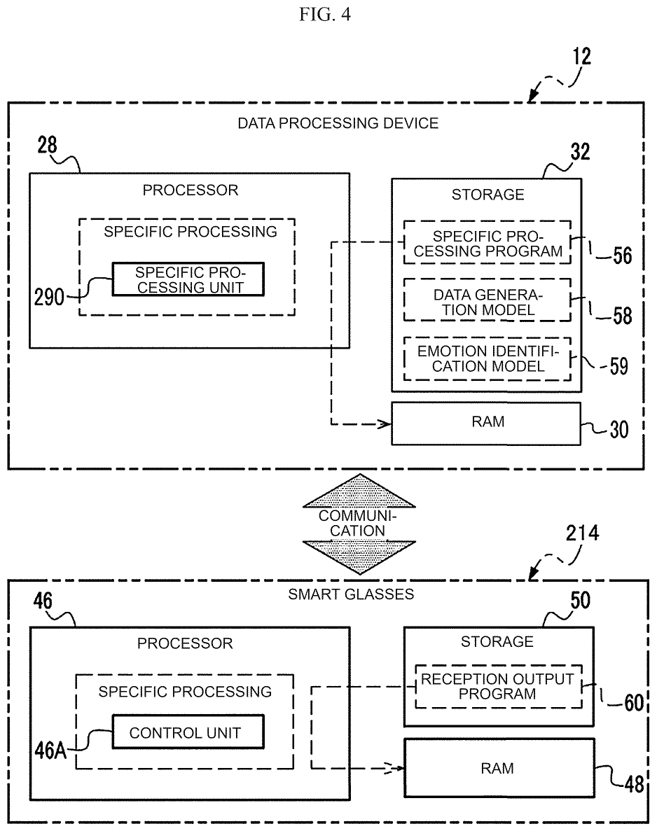

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

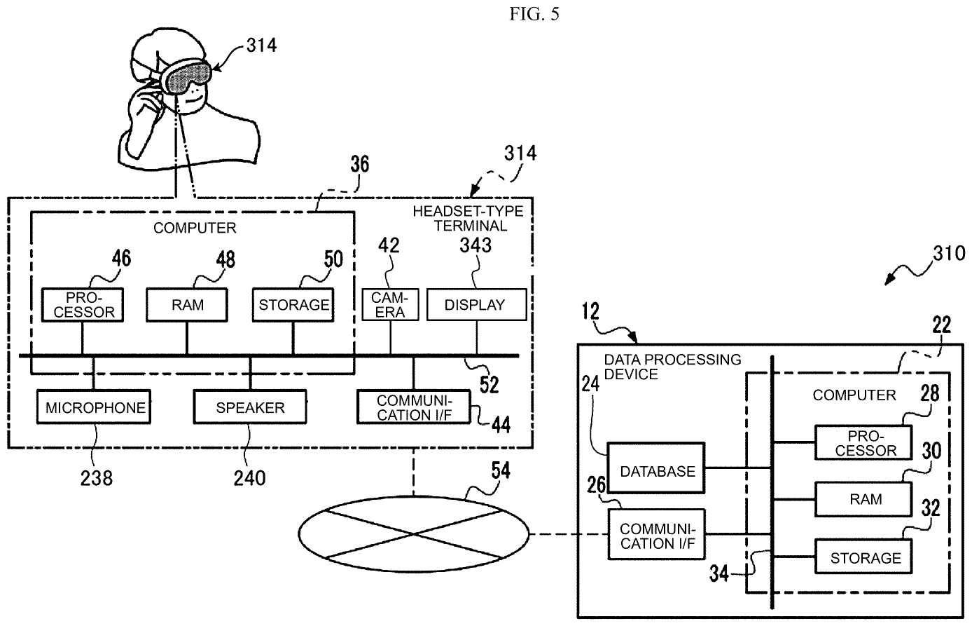

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

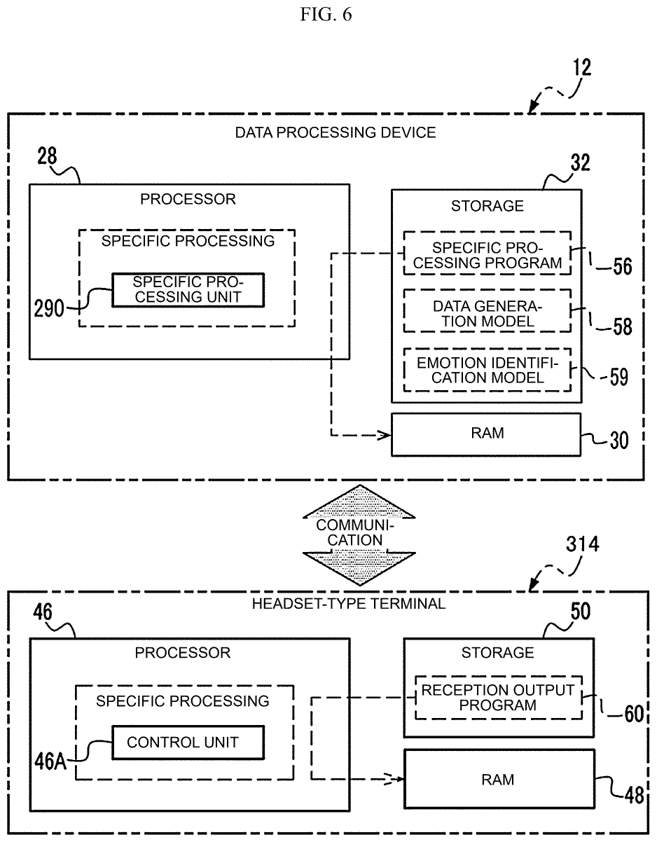

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

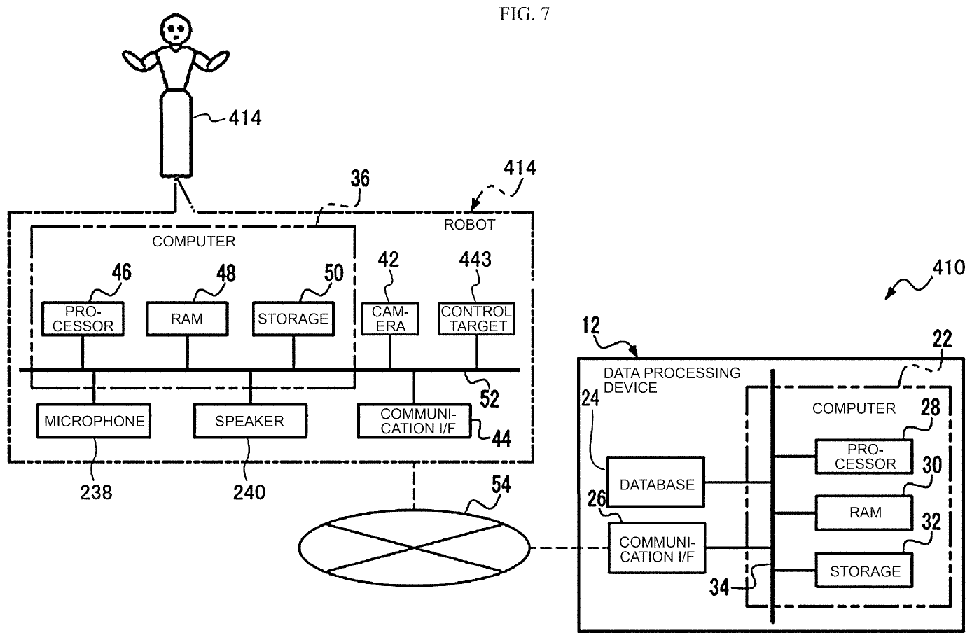

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

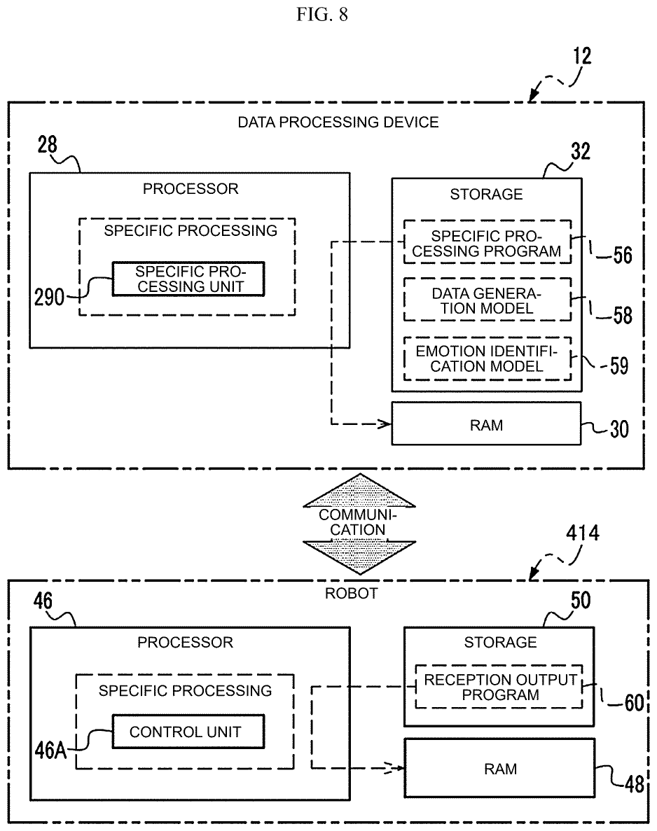

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

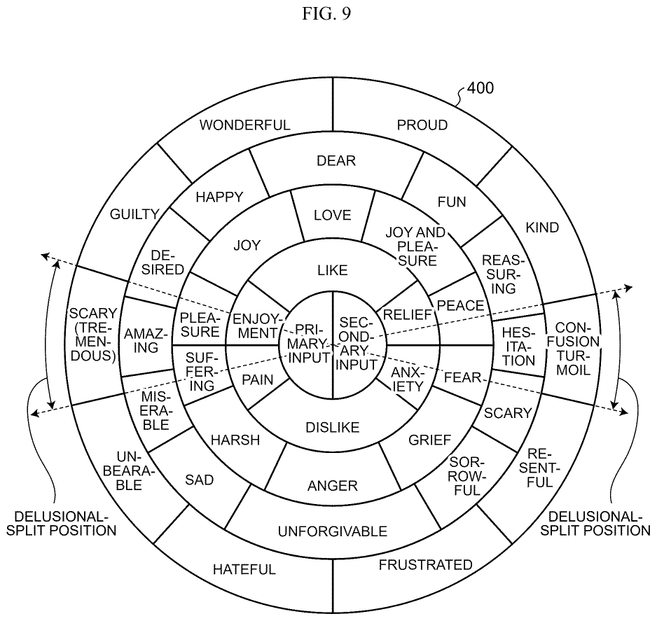

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

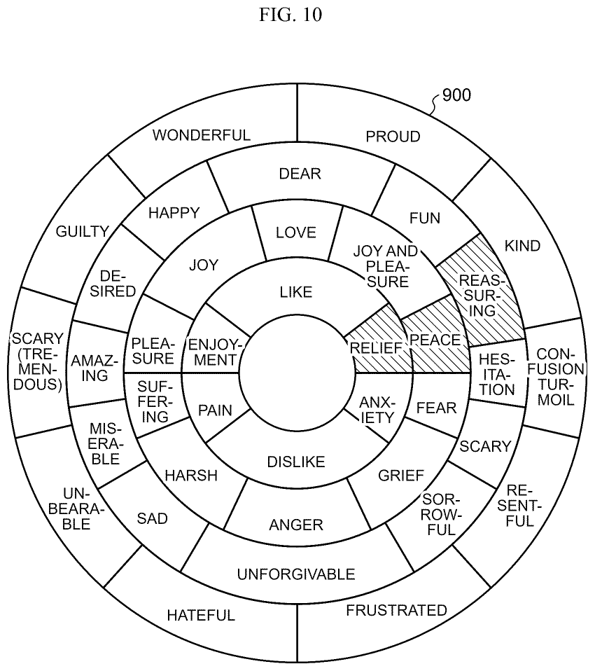

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.
(Supplementary Note 1)

A system comprising: a camera information acquisition unit; a sensor information acquisition unit; a generative AI analysis unit; an abnormality notification and management screen unit; and a data accumulation unit, wherein the camera information acquisition unit is configured to acquire video of robot operations in real time from a plurality of cameras installed in an automated line, an assembly cell, a transport system, a picking area, a welding process, a painting process, an inspection process, and the like in a factory; the sensor information acquisition unit is configured to acquire operation status and machine state data at regular intervals from an acceleration sensor, a temperature sensor, a current sensor, a vibration sensor, a position sensor, a torque sensor, an encoder, a proximity sensor, a pressure sensor, and the like mounted on each robot main body, an end effector, a control panel, and peripheral equipment; the generative AI analysis unit is configured to integrally analyze multidimensional data obtained from the camera information acquisition unit and the sensor information acquisition unit, learn a normal operation pattern, past abnormality cases, and an operation history for each robot, and automatically detect an arm operation abnormality, a failure sign, a work efficiency drop, a dangerous behavior, a process deviation, a human contact risk, a maintenance necessity, and the like with high accuracy; the abnormality notification and management screen unit is configured to, when an abnormality or a sign is detected, immediately transmit a detailed notification including identification information of a corresponding robot, abnormality details, an occurrence time, a recommended response procedure, a latest video clip and sensor graph, a past similar case, a severity level, an urgency level determination, and the like to a terminal of an administrator or a maintenance person, and visualize an operation status of all robots, an abnormality occurrence history, a maintenance recommendation, a work efficiency transition, a past response history, a risk prediction by AI, an abnormality occurrence tendency by process, and the like in a list and a graph on a management screen; and the data accumulation unit is configured to store all video data, sensor data, abnormality detection histories, and response histories for a long period of time so as to be usable for future AI model relearning, trouble analysis, process improvement proposal, and the like.
(Supplementary Note 2)

The system according to Supplementary Note 1, wherein the generative AI analysis unit is configured to extract an operation pattern and a work procedure of the robot from a camera video, determine an operation speed and acceleration of an arm, smoothness of a trajectory, a gripping/releasing timing of a workpiece, a trajectory deviation of a welding torch, a workpiece drop or miss during picking, a defective product detection operation in an inspection process, and the like with high accuracy, extract, regarding sensor data, a sign of bearing wear or gear loss from an abnormality pattern of an acceleration waveform, a motor burnout risk from a simultaneous fluctuation of a temperature rise and a current value, an overload or mechanical interference from a combination of a torque fluctuation and a position shift, a gripping mistake or a workpiece drop from an abnormal value of a pressure sensor, a contact risk with a person or other equipment from a reaction of a proximity sensor, and the like by multivariate analysis, learn past normal operation data, an abnormality occurrence history, an aging degradation tendency for each robot, a work pattern for each process, and a fluctuation of a season and an operating environment, and automatically generate an individually optimized abnormality detection algorithm.
(Supplementary Note 3)

The system according to Supplementary Note 1, wherein the abnormality notification and management screen unit is configured to, when an abnormality, a failure sign, a work efficiency drop, a dangerous behavior, a maintenance necessity, or the like is detected, immediately transmit a detailed notification including identification information of a corresponding robot, abnormality details, an occurrence time, a recommended response procedure, a latest video clip and sensor graph, a past similar case, a severity level, an urgency level determination, and the like to a terminal of an administrator or a maintenance person, and visualize an operation status of all robots, an abnormality occurrence history, a maintenance recommendation, a work efficiency transition, a past response history, a risk prediction by AI, an abnormality occurrence tendency by process, and the like in a list and a graph on a management screen, and all data is stored in the data accumulation unit for a long period of time so as to be usable as basis data for re-verification of a past abnormality occurrence case, relearning of an AI model, trouble cause analysis, a process improvement proposal, and a capital investment plan.

What is claimed is:

1. A system comprising:
circuitry configured to:
receive, via a communication interface coupled to a packet-switched network, video stream data from a plurality of imaging devices and telemetry data from sensor devices mounted on automated equipment, and store the video stream data and telemetry data in a storage device;
apply a convolutional neural network to video frame tensors extracted from the video stream data to classify detected object actions into activity category labels and record the activity category labels in chronological order, and apply a time-series anomaly detection model to the telemetry data to compute a reconstruction error score for each monitored equipment identifier;
apply a multimodal fusion model to the activity category labels and the reconstruction error scores to generate an integrated anomaly indicator, and apply a generative neural network model to the integrated anomaly indicator to generate an anomaly classification record comprising an anomaly type identifier, a severity score, and a recommended response action sequence when the integrated anomaly indicator exceeds an anomaly threshold parameter; and
transmit the anomaly classification record and a visualization data record derived from the video stream data and the telemetry data to terminal devices via the communication interface.

2. The system according to claim 1, wherein the circuitry is configured to
apply the convolutional neural network to video frame tensors at edge computing nodes proximate to the imaging devices to perform initial feature extraction, generate compact spatial feature vectors, and transmit only the compact spatial feature vectors to a cloud computing node via the communication interface for multimodal fusion processing.

3. The system according to claim 2, wherein the circuitry is configured to
apply a three-dimensional convolutional neural network to a temporal sequence of video frame tensors at the cloud computing node to extract spatiotemporal feature vectors representing motion patterns, and incorporate the spatiotemporal feature vectors alongside the compact spatial feature vectors in the multimodal fusion model.

4. The system according to claim 1, wherein the circuitry is configured to
apply the time-series anomaly detection model as an autoencoder pre-trained on telemetry data representing normal equipment operating conditions, compute a reconstruction error between the input telemetry array and the autoencoder output, and generate a telemetry anomaly signal when the reconstruction error exceeds a telemetry anomaly threshold parameter.

5. The system according to claim 4, wherein the circuitry is configured to
apply a one-dimensional convolutional neural network to time-series telemetry arrays to extract frequency-domain features, apply a long short-term memory network to the extracted features to generate multi-step ahead telemetry prediction values, and incorporate the prediction error as an additional anomaly indicator.

6. The system according to claim 1, wherein the circuitry is configured to
apply the multimodal fusion model by concatenating the activity category label embedding vector with the reconstruction error score vector in a shared feature space, and applying a cross-attention mechanism to compute weighted interactions between vision-derived features and sensor-derived features.

7. The system according to claim 1, wherein the circuitry is configured to
detect a human proximity event by applying a human detection model to video frame tensors to identify human pose keypoints within a configurable proximity radius of automated equipment, generate a human proximity alert when a human proximity event is detected, and incorporate the human proximity alert as an additional input to the multimodal fusion model.

8. The system according to claim 7, wherein the circuitry is configured to
transmit an immediate equipment deceleration command to an automated equipment control interface via the communication interface when a human proximity alert is generated within a critical proximity zone parameter, and log the deceleration command with a timestamp and equipment identifier in an audit log data structure.

9. The system according to claim 1, wherein the circuitry is configured to
apply the generative neural network model to the anomaly classification record and historical anomaly records retrieved from a vector database by cosine similarity search to generate the recommended response action sequence, and incorporate maintenance procedure records associated with the anomaly type identifier from the vector database as reference context.

10. The system according to claim 9, wherein the circuitry is configured to
transmit the recommended response action sequence to a terminal device associated with a maintenance personnel user identifier, receive a task completion record from the terminal device via the communication interface, and store the task completion record with the corresponding anomaly classification record in the storage device as a validated resolution case record.

11. The system according to claim 1, wherein the circuitry is configured to
generate the visualization data record by overlaying the activity category labels and anomaly indicators as annotation layers on video frame thumbnails, and generating equipment state heat maps from the telemetry data, and transmit the visualization data record to a management dashboard terminal device via the communication interface.

12. The system according to claim 1, wherein the circuitry is configured to
store all video stream data, telemetry data, activity category labels, anomaly classification records, and response action records in a long-term archive data structure in the storage device with timestamps and equipment identifiers for subsequent analysis.

13. The system according to claim 1, wherein the circuitry is configured to
aggregate anomaly classification records across all monitored equipment identifiers over a configurable time window, apply the generative neural network model to generate a predictive maintenance insight report identifying recurring anomaly patterns, and transmit the report to terminal devices associated with operational management user identifiers.

14. The system according to claim 1, wherein the circuitry is configured to
apply a process deviation detection model to the activity category label time series by comparing observed activity sequences against expected activity sequence templates, generate a process deviation alert when a significant deviation is detected, and incorporate the process deviation alert in the anomaly classification record.

15. The system according to claim 1, wherein the circuitry is configured to
update the convolutional neural network and the time-series anomaly detection model by generating training pairs from historical video frame tensors and telemetry arrays paired with validated anomaly labels, and fine-tune the models to improve detection accuracy for specific equipment type and activity category combinations.

16. The system according to claim 1, wherein the circuitry is configured to
encrypt video stream data and telemetry data transmissions between imaging devices, sensor devices, and the system using a transport layer security protocol, and authenticate each imaging device and sensor device using a device certificate.

17. The system according to claim 1, wherein the imaging devices are distributed across work zones in a manufacturing facility comprising automated equipment operation areas, the sensor devices are mounted on the automated equipment and peripheral devices, and the anomaly classification record identifies operational anomalies, failure signs, and safety proximity events detected across the facility.

18. A system comprising:
circuitry configured to:
receive, via a communication interface coupled to a packet-switched network, video stream data from imaging devices and telemetry data from sensor devices on automated equipment;
apply a convolutional neural network to extract activity category labels from video frames at edge computing nodes, and apply an autoencoder anomaly detection model to telemetry arrays to compute reconstruction error scores;
apply a multimodal fusion model with a cross-attention mechanism to integrate vision-derived and sensor-derived features into an integrated anomaly indicator, and apply a generative neural network model to generate anomaly classification records;
detect human proximity events using a human detection model and transmit deceleration commands to equipment control interfaces; and
transmit anomaly classification records and visualization data to terminal devices via the communication interface.

19. The system according to claim 18, wherein the circuitry is configured to
apply a one-dimensional convolutional neural network and long short-term memory network to generate multi-step ahead telemetry prediction values, apply a process deviation detection model to activity label sequences, and generate a predictive maintenance insight report from aggregated anomaly classification records across all monitored equipment identifiers.

20. A method comprising:
receiving, via a communication interface coupled to a packet-switched network, video stream data from imaging devices and telemetry data from sensor devices on automated equipment, and storing the data in a storage device;
applying a convolutional neural network to video frame tensors to classify activity category labels, and applying a time-series anomaly detection model to telemetry data to compute reconstruction error scores;
applying a multimodal fusion model to generate an integrated anomaly indicator, and applying a generative neural network model to generate an anomaly classification record comprising an anomaly type identifier, a severity score, and a recommended response action sequence; and
transmitting the anomaly classification record and visualization data to terminal devices via the communication interface.
